(19) United States
(12) Patent Application Publication
(10) Pub. No.: US 2026/0165322 A1
(43) Pub. Date: Jun. 18, 2026

(54) FORMULATIONS CONTAINING PYRIDINE CARBOXYLATE HERBICIDES AND METHODS OF USE

(71) Applicant: CORTEVA AGRISCIENCE LLC, INDIANAPOLIS, IN (US)

(72) Inventors: FRANCIS ADMANA, PLAINFIELD, IN (US); BETH MOSCATO, INDIANAPOLIS, IN (US); BRITTANY RAUZAN, BROWNSBURG, IN (US); NORBERT M. SATCHIVI, CARMEL, IN (US); JENNIFER SKELTON, WHITESTOWN, IN (US); STEPHEN L. WILSON, ZIONSVILLE, IN (US)

(73) Assignee: CORTEVA AGRISCIENCE LLC, INDIANAPOLIS, IN (US)

(21) Appl. No.: 19/417,615

(22) Filed: Dec. 12, 2025

Related U.S. Application Data
(60) Provisional application No. 63/733,095, filed on Dec. 12, 2024.

(51) Int. Cl. A01N 43/40; A01N 25/04; A01P 13/00

(52) U.S. Cl. CPC A01N 43/40; A01N 25/04; A01P 13/00

(57) ABSTRACT

Disclosed herein are formulations comprising a pyridine carboxylic acid herbicide or an agriculturally acceptable ester, N-oxide, or salt thereof. Also disclosed herein are methods of controlling undesirable vegetation, comprising applying to vegetation or an area adjacent the vegetation or applying in soil or water to control the emergence or growth of vegetation a formulation comprising a pyridine carboxylic acid herbicide or an agriculturally acceptable ester, N-oxide, or salt thereof.

### PRIORITY CLAIM

This application claims the benefit of U.S. provisional patent application No. 63/733,095, filed on Dec. 12, 2024, which provisional application is incorporated by reference herein in its entirety.

### FIELD

The present disclosure relates to herbicidal formulations containing pyridine carboxylic acid herbicides, and agriculturally acceptable esters, N-oxides, or salts thereof. The present disclosure also relates to methods of using herbicidal formulations containing these pyridine carboxylic acid herbicides, or agriculturally acceptable esters, N-oxides, or salts thereof.

### BACKGROUND

Many recurring problems in agriculture involve controlling the growth of undesirable vegetation that can, for instance, negatively affect the growth of desirable vegetation. To help control undesirable vegetation, researchers have produced a variety of herbicidal chemicals effective in controlling such unwanted growth. While these herbicidal chemicals may be used neat, it is typically preferable to incorporate the herbicidal chemicals in formulations. Such formulations may be liquid formulations or solid formulations. Such formulations can be designed to be: stable under typical storage conditions; easy for the end user to transport, dilute, mix, and apply; safe for the end user and the environment; and effective in controlling undesirable vegetation. Achieving most or all of these goals can be challenging. Therefore, there is an ongoing need for herbicide formulations that are stable, easy to use, safe, and effective.

### SUMMARY

Disclosed herein are herbicidal formulations that contain a pyridine carboxylic acid compound, or an agriculturally acceptable ester, N-oxide, or salt thereof. In some aspects, the formulation comprises the pyridine carboxylate acid or ester compound defined by Formula I:

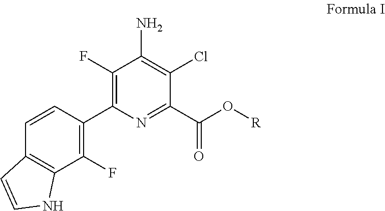

wherein R is H, C₁-C₆ alkyl, substituted C₁-C₆ alkyl, C₂-C₆ alkenyl, substituted C₂-C₆ alkenyl, C₂-C₆ alkynyl, substituted C₂-C₆ alkynyl, phenyl, substituted phenyl, C₇-C₁₂ arylalkyl, substituted C₇-C₁₂ arylalkyl, C₁-C₆ alkoxy, C₁-C₆ alkoxyalkyl, C₇-C₁₂ aryloxyalkyl, C₁-C₆ alkylthio, C₁-C₆ alkylthioalkyl, C₇-C₁₂ arylthioalkyl, or an agriculturally acceptable N-oxide or salt thereof.

In some aspects, the formulation of the pyridine carboxylic acid herbicide or an agriculturally acceptable ester, N-oxide or salt thereof may be present in suspended liquid, emulsified liquid, dissolved liquid, paste, gel, or solid form. Exemplary formulations include, but are not limited to, aqueous solutions, aqueous suspensions, aqueous dispersions, aqueous emulsions, aqueous microemulsions, aqueous suspo-emulsions, oil solutions, oil suspensions, oil dispersions, oil emulsions, oil microemulsions, oil suspo-emulsions, self-emulsifying formulations, pastes, gels, powders, dusts, granules, and materials for spreading. In some aspects, the formulation can be provided as a herbicidal concentrate. In some aspects, the formulation can be provided as a ready-to-use composition. In some aspects, the formulation can further comprise an agriculturally acceptable adjuvant or carrier, a herbicidal safener, an additional pesticide, or combinations thereof.

Also disclosed herein are methods of controlling undesirable vegetation, comprising applying to the undesirable vegetation, to an area adjacent the undesirable vegetation, or to soil or water prior to the emergence or growth of the undesirable vegetation, a formulation comprising a pyridine carboxylic acid herbicide or an agriculturally acceptable ester, N-oxide, or salt thereof. In some aspects, the formulation is applied pre-emergence of the undesirable vegetation. In some aspects, the formulation is applied post-emergence of the undesirable vegetation. In some aspects, the undesirable vegetation is in cereals. In some aspects, the undesirable vegetation is in maize (corn), wheat, barley, rice, sorghum, millet, or oats. In some aspects, the undesirable vegetation is in broadleaf crops. In some aspects, the undesirable vegetation is in canola, flax, sunflower, soy, or cotton. In some aspects, the undesirable vegetation is in range and pasture lands.

In some aspects, the pyridine carboxylate herbicide is present in a liquid concentrate formulation at a concentration from 1 to 500 gram active ingredient per liter (g ai/L) of the liquid concentrate formulation. In some aspects, the pyridine carboxylate herbicide is present in a liquid tank mix formulation at a concentration from 0.006 to 100 gram active ingredient per liter (g ai/L) of the liquid tank mix formulation. In some aspects, the pyridine carboxylate herbicide is present in a solid formulation at a concentration from 1 to 500 gram active ingredient per kilogram (g ai/kg) of the solid formulation.

The description below sets forth details of one or more aspect of the present disclosure. Other features, objects, and advantages will be apparent from the description and from the claims.

### BRIEF DESCRIPTION OF THE DRAWINGS

FIG. 1 is an 19F NMR spectrum of Compound A dissolved in Tamisolve® NxG, after storage at −10° C. or 54° C. for two weeks.

FIG. 2 is an 19F NMR spectrum of Compound A dissolved in Agnique® AMD 3L, after storage at −10° C. or 54° C. for two weeks.

FIG. 3 is an 19F NMR spectrum of Compound A dissolved in benzyl alcohol, after storage at −10° C. or 54° C. for two weeks.

### DETAILED DESCRIPTION

The present disclosure includes formulations comprising a pyridine carboxylic acid herbicide or an agriculturally acceptable ester, N-oxide, or salt thereof. The present disclosure also includes methods for controlling undesirable vegetation. In some aspects, the undesirable vegetation is in cereals. In some aspects, the undesirable vegetation is in maize (corn), wheat, barley, rice, sorghum, millet, or oats. In some aspects, the undesirable vegetation is in broadleaf crops. In some aspects, the undesirable vegetation is in canola, flax, sunflower, soy, or cotton. In some aspects, the undesirable vegetation is in range and pasture lands.

### I. Definitions

Terms used herein will have their customary meaning in the art unless specified otherwise. The singular forms “a” and “the” include plural references unless stated otherwise. To the extent that the term “or” is employed (e.g., A or B) it is intended to mean “A or B or both.” Thus, use of the term “or” herein is the inclusive and not the exclusive use.

The chemical moieties mentioned when defining variable substituents within the general formulae described herein (e.g., the term “alkyl”) are collective terms for the individual substituents encompassed by the chemical moiety. The prefix Cn-Cm preceding a group or moiety indicates, in each case, the possible number of carbon atoms in the group or moiety that follows.

As used herein, the terms “pyridine carboxylate herbicide” or “pyridine carboxylate compound” may be understood to refer interchangeably to the compounds of Formula I. The terms “pyridine carboxylate herbicide” or “pyridine carboxylate compound” may also be understood to include the acid, ester, N-oxide, or salt forms of the compounds of Formula I.

As used herein, the terms “herbicide,” “herbicidal chemical,” and “herbicidal active ingredient” may be understood to include an active ingredient that exhibits a herbicidal effect that kills, injures, damages, controls, or otherwise adversely modifies the growth of vegetation, particularly undesirable vegetation such as weed species, when applied in an appropriate amount.

As used herein, the terms “herbicidal formulation” or “formulation” may be understood to include compositions that comprise at least one herbicide and at least one additional component. The additional component may be a solvent, a diluent, a carrier, an adjuvant, a surfactant, a dispersant, a chemical stabilizer, a physical stabilizer, a dye or colorant, or other such component. The additional component may be another herbicide or another agricultural chemical, such as an insecticide, a fungicide, a fertilizer, a nematocide, a miticide, a arthropodicide, a bactericide, a plant growth regulator, or combinations thereof that are compatible with the formulations of the present disclosure.

As used herein, the terms “concentrate formulation” or “concentrate” may be understood to include compositions that comprise at least one herbicide and at least one additional component, where the concentrate formulation is intended to be diluted with a diluting solvent before use. The additional component may be a solvent, a diluent, a carrier, an adjuvant, a surfactant, a dispersant, a chemical stabilizer, a physical stabilizer, a dye or colorant, or other such component. The additional component may be another herbicide or another agricultural chemical, such as an insecticide, a fungicide, a fertilizer, a nematocide, a miticide, a arthropodicide, a bactericide, a plant growth regulator, or combinations thereof that are compatible with the formulations of the present disclosure. The diluting solvent may be, but is not limited to, water or an aqueous liquid.

As used herein, the term “tank mix” may be understood to refer to a herbicidal formulation that is intended to be used as-is without further dilution. For example, a tank mix may be prepared from a concentrate formulation by the end user, by diluting the concentrate formulation with a diluting solvent. The end user may also add other ingredients to the tank mix, stir or agitate the ingredients to homogeneously distribute them in the tank mix, or conduct other such activities to prepare the tank mix for application. The end user may then apply the tank mix to the undesirable vegetation or locus thereof. In some aspects, the tank mix may be applied with other ingredients, formulations, or tank mixes, and the application(s) may occur either concurrently or sequentially. A tank mix may also be packaged and sold commercially to the end user, for instance, in a jug, spray bottle, aerosol can, or other such packaging, for use as-is on undesirable vegetation.

As used herein, the term “adjuvant” may be understood to include additives to the formulation or tank mix that, while having no herbicidal effect in themselves, help to stabilize, increase, or otherwise enhance the herbicidal effect of the herbicidal active ingredient. For example, adjuvants may be surfactants that enhance the absorption of the herbicidal active ingredient into the plant. Adjuvants may be added to the formulation, or adjuvants may be added to the herbicide tank mix by the end user prior to application of the tank mix. Adjuvants may also be included in the herbicide formulation, in which case the adjuvant may be referred to as a “built-in adjuvant.”

As used herein, the term “herbicidal effect” may be understood to include an adversely modifying effect of an active ingredient (e.g., a herbicide) on vegetation, including, for example, a deviation from natural growth or development, killing, regulation, desiccation, growth inhibition, growth reduction, and retardation. The term “herbicidal activity” refers generally to herbicidal effects of an active ingredient. As used herein, the terms “prevent,” “reduce,” “control,” or similar terms such as “preventing,” “reducing,” or “controlling” may be understood by a person of ordinary skill to include herbicide or herbicidal formulation that shows a herbicidal effect or adversely modifies the competitive capability of the weed with respect to a crop; however, it should be understood that “preventing,” “reducing,” or “controlling” is not meant to imply complete or 100% control of the undesirable vegetation.

As used herein, “applying” a herbicide or herbicidal formulation refers to delivering the herbicide or herbicidal formulation directly to the targeted vegetation or to the locus thereof or to the area where control of undesirable vegetation is desired. Methods of application include, but are not limited to, pre-emergently contacting soil or water, post-emergently contacting the undesirable vegetation, or contacting the area adjacent to the undesirable vegetation.

As used herein, the term “vegetation” can include, for instance, dormant seeds, germinating seeds, emerging seedlings, plants propagating from vegetative propagules, immature vegetation, and established vegetation.

As used herein, the term “crop” refers to desired vegetation, for instance, plants that are grown to provide food, shelter, pasture, erosion control, etc. Example crops include cereals, legumes, vegetables, orchard and timber trees, grapevines, etc. Preferably, herbicides or herbicidal compositions have no or minimal herbicidal effect on crops.

As used herein, the term “undesirable vegetation” refers to vegetation that is not wanted in a given area, for instance, weed species. Herbicides or herbicidal formulations are used to control undesirable vegetation. Preferably, herbicides or herbicidal formulations have a large or complete herbicidal effect on undesirable vegetation.

As used herein, “active ingredient” or “ai” may be understood to include a chemical compound or composition that has an effect on vegetation, for example, a herbicidal effect or a safening effect on the vegetation. The term “active ingredient” or “ai” may also be used in expressions relating concentrations or applications rates, such as “grams active ingredient per hectare” or “g ai/ha” to clarify that the amount of the ingredient is measured as the compound as-is, including salts, esters, N-oxides, hydrates, etc.

As used herein, “acid equivalent” or “ae” may be understood to include the amount of the acid form of an active ingredient that is calculated from the amount of a salt, ester, N-oxide, or hydrate form of that active ingredient. For example, if the acid form of an active ingredient “Z” has a molecular weight of 100 Dalton, and the salt form of Z has a molecular weight of 130 Dalton, an application of 130 g ai/ha of the Z salt would be equal to applying 100 g ae/ha of the acid form of Z:

130 g ai/ha Z salt*(100 Da Z acid/130 Da Z salt)=100 g ae/ha Z acid.

The term “acid equivalent” or “ae” may also be used in expressions relating concentrations or applications rates, such as “grams acid equivalent per hectare” or “g ae/ha” to clarify that the amount of the ingredient is measured as the acid form of the compound, corrected to eliminate the mass contribution of associated salts, esters, N-oxides, hydrates, etc.

As used herein, “organic liquid” or “organic solvent” may be understood to refer to organic compounds (that is, compounds comprising carbon atoms) that are liquid at most or all typical ambient outdoor temperatures, such as from about −10° C. to 55° C., about 0° C. to 40° C., about 5° C. to about 50° C., or about 8° C. to 38° C. Organic liquids are frequently, although not always, hydrophobic and immiscible in water or aqueous liquids. It should be understood that the term “organic solvent” does not necessarily imply that any material mixed into the organic solvent dissolves in the organic solvent.

As used herein, “agriculturally acceptable esters, N-oxides, or salts” may be understood to include esters, N-oxides, or salts of herbicides that are approved for use in agricultural applications. Agriculturally acceptable esters, N-oxides, or salts may be converted in plants, water, or soil to the referenced herbicide. For example, agriculturally acceptable salts are those that are or can be hydrolyzed, oxidized, metabolized, or otherwise converted in plants, water, sunlight, or soil, to the corresponding carboxylic acid which, depending on the pH, may be in the dissociated or undissociated form.

The pyridine carboxylate compounds described herein can include N-oxides. Pyridine N-oxides can be obtained by oxidation of the corresponding pyridines. Suitable oxidation methods are described, for example, in Houben-Weyl, Methoden der organischen Chemie [Methods in organic chemistry], expanded and subsequent volumes to the 4th edition, volume E 7b, p. 565 f.

### II. Pyridine Carboxylate Herbicides

Formulations and methods of the present disclosure include formulations comprising a pyridine carboxylate compound. In some aspects, the formulation comprises the pyridine carboxylate compound defined by Formula I:

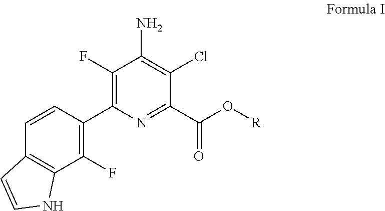

wherein R is H, C₁-C₆ alkyl, substituted C₁-C₆ alkyl, C₂-C₆ alkenyl, substituted C₂-C₆ alkenyl, C₂-C₆ alkynyl, substituted C₂-C₆ alkynyl, phenyl, substituted phenyl, C₇-C₁₂ arylalkyl, substituted C₇-C₁₂ arylalkyl, C₁-C₆ alkoxy, C₁-C₆ alkoxyalkyl, C₇-C₁₂ aryloxyalkyl, C₁-C₆ alkylthio, C₁-C₆ alkylthioalkyl, C₇-C₁₂ arylthioalkyl, or an agriculturally acceptable N-oxide or salt thereof. In some aspects, the formulation comprises a pyridine carboxylate compound selected from the following compounds in Table 1, or agriculturally acceptable N-oxides or salts thereof.

TABLE 1
Compounds of Formula I

| Com- | |
|---|---|
| pound | |
| ID | Structure |
| A | 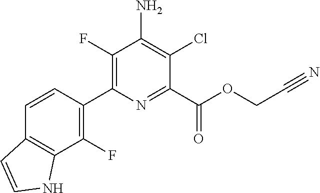 [SMILES: N#CCOC(=O)c1nc(-c2ccc3cc[nH]c3c2F)c(F)c(N)c1Cl] |
| B | 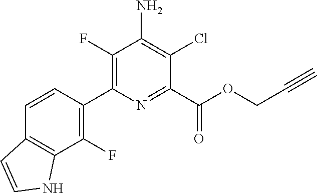 [SMILES: C#CCOC(=O)c1nc(-c2ccc3cc[nH]c3c2F)c(F)c(N)c1Cl] |
| C | 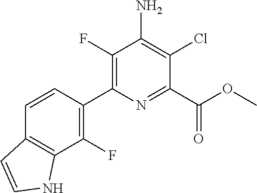 [SMILES: COC(=O)c1nc(-c2ccc3cc[nH]c3c2F)c(F)c(N)c1Cl] |
| D | 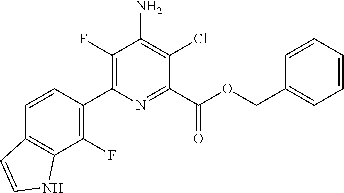 [SMILES: Nc1c(F)c(-c2ccc3cc[nH]c3c2F)nc(C(=O)OCc2ccccc2)c1Cl] |
| E | 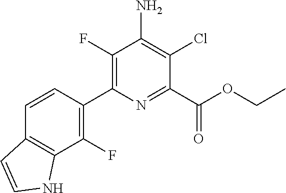 [SMILES: CCOC(=O)c1nc(-c2ccc3cc[nH]c3c2F)c(F)c(N)c1Cl] |
| F | 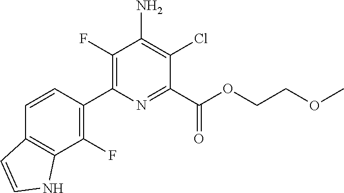 [SMILES: COCCOC(=O)c1nc(-c2ccc3cc[nH]c3c2F)c(F)c(N)c1Cl] |
| G | 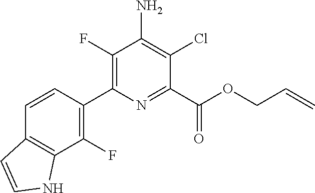 [SMILES: C=CCOC(=O)c1nc(-c2ccc3cc[nH]c3c2F)c(F)c(N)c1Cl] |
| H | 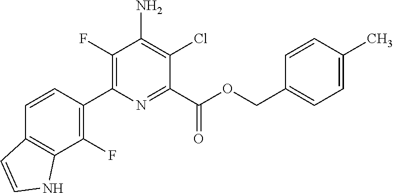 [SMILES: Cc1ccc(COC(=O)c2nc(-c3ccc4cc[nH]c4c3F)c(F)c(N)c2Cl)cc1] |
| I | 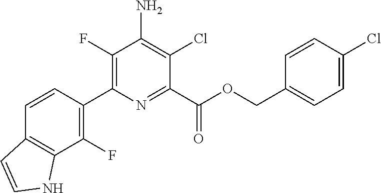 [SMILES: Nc1c(F)c(-c2ccc3cc[nH]c3c2F)nc(C(=O)OCc2ccc(Cl)cc2)c1Cl] |
| J | 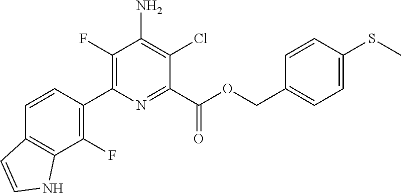 [SMILES: CSc1ccc(COC(=O)c2nc(-c3ccc4cc[nH]c4c3F)c(F)c(N)c2Cl)cc1] |
| K | 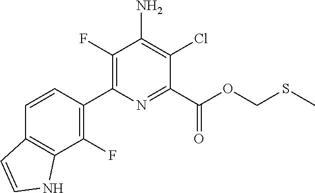 [SMILES: CSCOC(=O)c1nc(-c2ccc3cc[nH]c3c2F)c(F)c(N)c1Cl] |
| L | 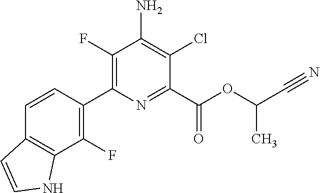 [SMILES: CC(C#N)OC(=O)c1nc(-c2ccc3cc[nH]c3c2F)c(F)c(N)c1Cl] |
| M | 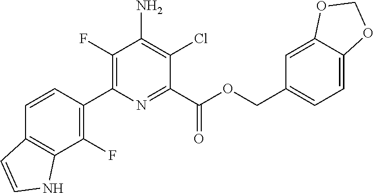 [SMILES: Nc1c(F)c(-c2ccc3cc[nH]c3c2F)nc(C(=O)OCc2ccc3c(c2)OCO3)c1Cl] |
| N | 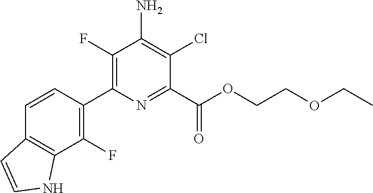 [SMILES: CCOCCOC(=O)c1nc(-c2ccc3cc[nH]c3c2F)c(F)c(N)c1Cl] |
| O | 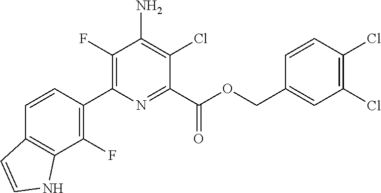 [SMILES: Nc1c(F)c(-c2ccc3cc[nH]c3c2F)nc(C(=O)OCc2ccc(Cl)c(Cl)c2)c1Cl] |
| P | 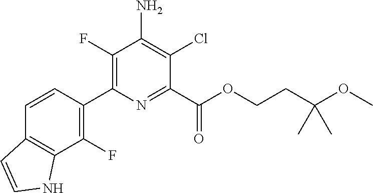 [SMILES: COC(C)(C)CCOC(=O)c1nc(-c2ccc3cc[nH]c3c2F)c(F)c(N)c1Cl] |
| Q | 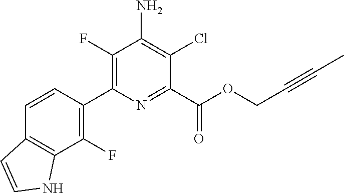 [SMILES: CC#CCOC(=O)c1nc(-c2ccc3cc[nH]c3c2F)c(F)c(N)c1Cl] |
| R | 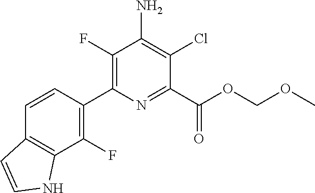 |
| S | 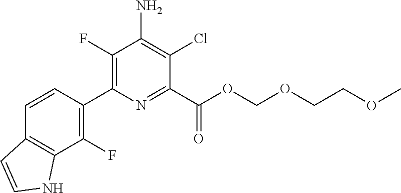 [SMILES: COCCOCOC(=O)c1nc(-c2ccc3cc[nH]c3c2F)c(F)c(N)c1Cl] |
| T | 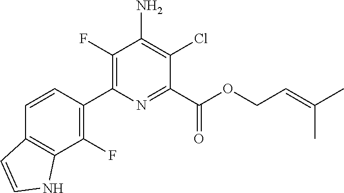 [SMILES: CC(C)=CCOC(=O)c1nc(-c2ccc3cc[nH]c3c2F)c(F)c(N)c1Cl] |
| U | 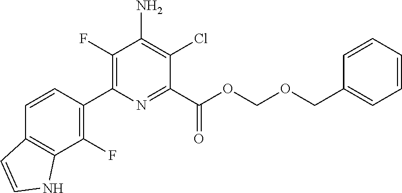 [SMILES: Nc1c(F)c(-c2ccc3cc[nH]c3c2F)nc(C(=O)OCOCc2ccccc2)c1Cl] |
| V | 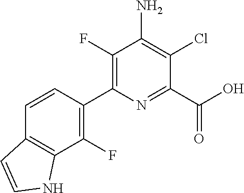 [SMILES: Nc1c(F)c(-c2ccc3cc[nH]c3c2F)nc(C(=O)O)c1Cl] |

Pyridine carboxylate herbicides, such as Compounds A-V, as well as methods of making these pyridine carboxylate herbicides, are disclosed in PCT publication WO 2014/151005, filed Mar. 12, 2014, and PCT publication WO 2018/208582, filed May 4, 2018, the entire disclosures of which are hereby expressly incorporated by reference.

In some aspects, the pyridine carboxylate herbicide can be provided as an agriculturally acceptable salt. Exemplary agriculturally acceptable salts of the pyridine carboxylate herbicides include, but are not limited to: sodium salts; potassium salts; ammonium salts or substituted ammonium salts, in particular mono-, di-, and tri-C₁-C₈-alkylammonium salts such as methyl ammonium, dimethylammonium and isopropylammonium; mono-, di- and tri-hydroxy-C₂-C₈-alkylammonium salts such as hydroxyethylammonium, di(hydroxyethyl) ammonium, tri (hydroxyethyl) ammonium, hydroxypropyl-ammonium, di(hydroxypropyl)-ammonium and tri (hydroxypropyl)-ammonium salts; olamine salts; diglycolamine salts; choline salts; and quaternary ammonium salts such as those represented by the formula R⁹R¹⁰R¹¹R¹²N⁺ and wherein R⁹, R¹⁰, R¹¹ and R¹² each independently can represent hydrogen, —OH, C₁-C₁₀ alkyl, C₂-C₈ alkenyl, C₂-C₈ alkynyl, C₁-C₈ alcohol, C₁-C₈ alkoxy, C₁-C₈alkoxyalkyl, C₁-C₈ alkylthio, C₁-C₈ alkylthioalkyl, or aryl groups, provided that R⁹—R¹² are sterically compatible.

The pyridine carboxylate herbicide can be applied to vegetation or an area adjacent the vegetation or applied to soil or water to prevent the emergence or growth of vegetation in an amount sufficient to induce a herbicidal effect. In some aspects, the pyridine carboxylate herbicide is applied to vegetation or an area adjacent the vegetation or applied to soil or water to prevent the emergence or growth of vegetation in an amount of 0.1 grams acid equivalent per hectare (g ae/ha) or greater, such as 0.2 g ae/ha or greater, 0.3 g ae/ha or greater, 0.4 g ae/ha or greater, 0.5 g ae/ha or greater, 0.6 g ae/ha or greater, 0.7 g ae/ha or greater, 0.8 g ae/ha or greater, 0.9 g ae/ha or greater, 1 g ae/ha or greater, 1.1 g ae/ha or greater, 1.2 g ae/ha or greater, 1.3 g ae/ha or greater, 1.4 g ae/ha or greater, 1.5 g ae/ha or greater, 1.6 g ae/ha or greater, 1.7 g ae/ha or greater, 1.8 g ae/ha or greater, 1.9 g ae/ha or greater, 2 g ae/ha or greater, 2.25 g ae/ha or greater, 2.5 g ae/ha or greater, 2.75 g ae/ha or greater, 3 g ae/ha or greater, 4 g ae/ha or greater, 5 g ae/ha or greater, 6 g ae/ha or greater, 7 g ae/ha or greater, 8 g ae/ha or greater, 9 g ae/ha or greater, 10 g ae/ha or greater, 11 g ae/ha or greater, 12 g ae/ha or greater, 13 g ae/ha or greater, 14 g ae/ha or greater, 15 g ae/ha or greater, 16 g ae/ha or greater, 17 g ae/ha or greater, 18 g ae/ha or greater, 19 g ae/ha or greater, 20 g ae/ha or greater, 22 g ae/ha or greater, 24 g ae/ha or greater, 25 g ae/ha or greater, 26 g ae/ha or greater, 28 g ae/ha or greater, 30 g ae/ha or greater, 32 g ae/ha or greater, 34 g ae/ha or greater, 35 g ae/ha or greater, 36 g ae/ha or greater, 38 g ae/ha or greater, 40 g ae/ha or greater, 42.5 g ae/ha or greater, 45 g ae/ha or greater, 47.5 g ae/ha or greater, 50 g ae/ha or greater, 52.5 g ae/ha or greater, 55 g ae/ha or greater, 57.5 g ae/ha or greater, 60 g ae/ha or greater, 65 g ae/ha or greater, 70 g ae/ha or greater, 75 g ae/ha or greater, 80 g ae/ha or greater, 85 g ae/ha or greater, 90 g ae/ha or greater, 95 g ae/ha or greater, 100 g ae/ha or greater, 110 g ae/ha or greater, 120 g ae/ha or greater, 130 g ae/ha or greater, 140 g ae/ha or greater, 150 g ae/ha or greater, 160 g ae/ha or greater, 170 g ae/ha or greater, 180 g ae/ha or greater, 190 g ae/ha or greater, 200 g ae/ha or greater, 210 g ae/ha or greater, 220 g ae/ha or greater, 230 g ae/ha or greater, 240 g ae/ha or greater, 250 g ae/ha or greater, 260 g ae/ha or greater, 270 g ae/ha or greater, 280 g ae/ha or greater, 290 g ae/ha or greater, 300 g ae/ha or greater, 310 g ae/ha or greater, 320 g ae/ha or greater, 330 g ae/ha or greater, 340 g ae/ha or greater, 350 g ae/ha or greater, 360 g ae/ha or greater, 370 g ae/ha or greater, 380 g ae/ha or greater, or 390 g ae/ha or greater; in an amount of 400 g ae/ha or less, such as 390 g ae/ha or less, 380 g ae/ha or less, 370 g ae/ha or less, 360 g ae/ha or less, 350 g ae/ha or less, 340 g ae/ha or less, 330 g ae/ha or less, 320 g ae/ha or less, 310 g ae/ha or less, 300 g ae/ha or less, 290 g ae/ha or less, 280 g ae/ha or less, 270 g ae/ha or less, 260 g ae/ha or less, 250 g ae/ha or less, 240 g ae/ha or less, 230 g ae/ha or less, 220 g ae/ha or less, 210 g ae/ha or less, 200 g ae/ha or less, 190 g ae/ha or less, 180 g ae/ha or less, 170 g ae/ha or less, 160 g ae/ha or less, 150 g ae/ha or less, 140 g ae/ha or less, 130 g ae/ha or less, 120 g ae/ha or less, 110 g ae/ha or less, 100 g ae/ha or less, 95 g ae/ha or less, 90 g ae/ha or less, 85 g ae/ha or less, 80 g ae/ha or less, 75 g ae/ha or less, 70 g ae/ha or less, 65 g ae/ha or less, 60 g ae/ha or less, 57.5 g ae/ha or less, 55 g ae/ha or less, 52.5 g ae/ha or less, 50 g ae/ha or less, 47.5 g ae/ha or less, 45 g ae/ha or less, 42.5 g ae/ha or less, 40 g ae/ha or less, 38 g ae/ha or less, 36 g ae/ha or less, 35 g ae/ha or less, 34 g ae/ha or less, 32 g ae/ha or less, 30 g ae/ha or less, 28 g ae/ha or less, 26 g ae/ha or less, 25 g ae/ha or less, 24 g ae/ha or less, 22 g ae/ha or less, 20 g ae/ha or less, 19 g ae/ha or less, 18 g ae/ha or less, 17 g ae/ha or less, 16 g ae/ha or less, 15 g ae/ha or less, 14 g ae/ha or less, 13 g ae/ha or less, 12 g ae/ha or less, 11 g ae/ha or less, 10 g ae/ha or less, 9 g ae/ha or less, 8 g ae/ha or less, 7 g ae/ha or less, 6 g ae/ha or less, 5 g ae/ha or less, 4 g ae/ha or less, 3 g ae/ha or less, 2.75 g ae/ha or less, 2.5 g ae/ha or less, 2.25 g ae/ha or less, 2 g ae/ha or less, 1.9 g ae/ha or less, 1.8 g ae/ha or less, 1.7 g ae/ha or less, 1.6 g ae/ha or less, 1.5 g ae/ha or less, 1.4 g ae/ha or less, 1.3 g ae/ha or less, 1.2 g ae/ha or less, 1.1 g ae/ha or less, 1 g ae/ha or less, 0.9 g ae/ha or less, 0.8 g ae/ha or less, 0.7 g ae/ha or less, 0.6 g ae/ha or less, 0.5 g ae/ha or less, 0.4 g ae/ha or less, 0.3 g ae/ha or less, or 0.2 g ae/ha or less; or in an amount within any range defined between any pair of the preceding values, such as 0.1-400 g ae/ha, 1-150 g ae/ha, 10-250 g ae/ha, 7-50 g ae/ha, 25-75 g ae/ha, 1.5-26 g ae/ha, 120-340 g ae/ha, 5-45 g ae/ha, or 40-100 g ae/ha.

### III. Formulations

The present disclosure includes formulations of the pyridine carboxylate herbicides and methods disclosed herein.

### A. Physical States

In some aspects, the formulation of the pyridine carboxylate herbicide may be present in suspended, emulsified, dissolved, or solid form. Exemplary formulations include, but are not limited to, aqueous suspensions, aqueous dispersions, aqueous emulsions, aqueous microemulsions, aqueous suspo-emulsions, oil solutions, oil suspensions, oil dispersions, oil emulsions, oil microemulsions, oil suspo-emulsions, self-emulsifying formulations, gels, pastes, powders, dusts, granules, and materials for spreading. A comprehensive list of formulation types with official definitions is available from CropLife International (croplife.org/wpcontent/uploads/-2017/04/Technical-Monograph-2-7th-Edition-Revised-March-2017.pdf).

i. Liquid Formulations

In some aspects, the formulation is a liquid formulation. Exemplary liquid formulations include, but are not limited to, emulsifiable concentrates, oil-in-water emulsions, water-in-oil emulsions, microemulsions, suspensions, suspension concentrates, capsule suspensions, suspoemulsions, oil dispersions, and soluble liquids. The liquid formulation may be a concentrate formulation that can be diluted with water by the end user, then applied by the end user as needed. The liquid formulation may be a tank mix that does not require dilution by the end user before use.

### a) Emulsions

Emulsions are two-phase (or multiple-phase) liquid mixtures containing two or more immiscible liquid phases, with fine droplets of one immiscible liquid phase dispersed in a continuous phase of the other immiscible liquid. Exemplary emulsion or emusifiable formulations include, but are not limited to, emulsifiable concentrates, oil-in-water emulsions, water-in-oil emulsions, or microemulsions.

Emulsifiable concentrates are homogeneous liquid formulations in hydrophobic organic liquids that become oil-in-water emulsions when diluted with water or an aqueous liquid by the end user. The diluted emulsion is then applied by the end user as needed.

Oil-in-water emulsions are liquid heterogeneous formulations containing an organic liquid dispersed as fine droplets in a continuous water or aqueous liquid phase. In one aspect, the herbicide active ingredient may be dissolved or dispersed in the organic liquid droplets dispersed in an oil-in-water emulsion. In another aspect, the herbicide active ingredient may be dissolved or dispersed in the continuous water or aqueous liquid phase of an oil-in-water emulsion.

Water-in-oil emulsions are liquid, heterogeneous formulations containing water or an aqueous liquid dispersed as fine droplets in a continuous hydrophobic organic liquid phase. In one aspect, the herbicide active ingredient may be dissolved or dispersed in the water or aqueous liquid droplets dispersed in a water-in-oil emulsion. In another aspect, the herbicideactive ingredient may be dissolved or dispersed in the continuous organic liquid phase of a water-in-oil emulsion.

Multi-phase emulsions, such as water-in-oil-in-water emulsions, are also known.

The size of the dispersed droplets in the above-described emulsions (also called “conventional emulsions”) is typically in the range of about 1 to 100 μm in diameter.

A microemulsion is a clear to opalescent liquid containing both organic liquid and water or an aqueous liquid. The microemulsion may be oil-in-water or water-in-oil emulsions, where the dispersed globules are very small, typically less than 1 μm. Microemulsions differ from conventional emulsions in that: a) the droplet size in microemulsions is smaller; b) microemulsions are typically clear or opalescent, whereas conventional emulsions are cloudy or milky; and c) microemulsions are thermodynamically stable and remain dispersed, whereas conventional emulsions are kinetically stable but thermodynamically unstable, and typically require mixing energy, such as high-shear mixing, to maintain the emulsion droplets dispersed within the continuous liquid phase.

Formulations comprising the pyridine carboxylate herbicides of the present disclosure may be emulsifiable concentrates, where the pyridine carboxylate herbicide is dissolved at a relatively high concentration in an organic liquid. The emulsifiable concentrate forms an oil-in-water emulsion when diluted with water before use. The emulsifiable concentrate formulation may also include ingredients including but not limited to, a co-solvent, an emulsifier, an antifoam agent, or a built-in adjuvant. Suitable organic solvents for forming emulsifiable concentrates of the pyridine carboxylate herbicides include, but are not limited to: long-chain alkyl amides, such as N,N-dimethylalkyl amide, Agnique® AMD 810 or Agnique® AMD 3L (Agnique® is a registered trademark of Cognis IP Management GmbH, Düsseldorf, Germany), Hallcomid® M-10 or Hallcomid® M-8-10 (Hallcomid® is a registered trademark of Stepan Company, Northfield, Illinois, USA), Genagen® 4166 (Genagen® is a registered trademark of Global Amines Company PTE, Ltd., Singapore), Tamisolve® NxG (Tamisolve is a registered trademark of Taminco, Ghent, Belgium), or Armid® DM810 (Armid® is a registered trademark of Nouryon, Amsterdam, Netherlands); aprotic glycol diethers, such as Proglyde® DMM (Proglyde® is a registered trademark of Dow Chemical Company, Midland, Michigan, USA); methylated seed oils, including C18 soyate and C18 rapeate, such as Agnique® ME 18 RD-F, Agnique® ME 18 SD-F, Agnique® ME 2337, or Edenor® ME 12-18 (Edenor® is a registered trademark of Emery Oleochemicals GmbH, Düsseldorf, Germany); fatty acid or triglyceride esters, such as Steposol® SC or Stepan® 108 (Steposol® and Stepan® are registered trademarks of Stepan Company, Northfield, Illinois, USA), Agnique® AE 3-2EH, or Purasolv® EHL (Purasolv® is a registered trademark of Purac Biochem B.V., Gorinchem, Netherlands); ketones such as 2-heptanone, cyclopentanone, acetophenone, or Cyrene® (Cyrene® is a registered trademark of Circa Group Pty Ltd, Coburg, Victoria, Australia); or phosphate triesters, such as Amgard® TOF (Amgard® is a registered trademark of Rhodia Operations, Aubervilliers, France). Suitable co-solvents for the emulsifiable concentrates of the pyridine carboxylate herbicides include, but are not limited to: alkylene carbonates, such as Jeffsol® AG 1505 or Jeffsol® AG 1555 (Jeffsol® is a registered trademark of Huntsman Petrochemical Corporation, Salt Lake City, Utah, USA); alkyl lactates, such as Agnique® AE 3-2EH, or Purasolv® EHL; cyclohexanone; high flash-point aromatic solvents, such as Aromatic 100, Aromatic 150, Aromatic 150-ND, Aromatic 200, or Aromatic 200 ND (Aromatic solvents are available from ExxonMobil Chemical Company, Spring, TX, USA); or aliphatic/paraffinic oils, such as Isopar® M or Exxsol® D130 (Isopar®, and Exxsol® are trademarks of ExxonMobil Corporation, Irving, Texas, USA); or diamides and ester amides, such as Rhodiasolv® PolarClean (Rhodiasolv® is a registered trademark of Rhodia Chimie SAS, Aubervilliers, France). Suitable emulsifiers include, but are not limited to, non-ionic, anionic, and polymeric emulsifiers. Suitable non-ionic emulsifiers include: ethoxylated castor oil, such as Agnique® CSO-25, Toximul® 8240 (Toximul® is a registered trademark of Stepan Company, Northfield, Illinois, USA), or Etocas™ 29 (Etocas™ is a trademark of Croda International Plc, Goole, East Yorkshire, UK); or alkoxylated fatty alcohols, such as Synperonic® 13/12 or Atlox® 4894 (Synperonic® and Atlox® are trademarks of Croda International Plc, Goole, East Yorkshire, UK). Suitable anionic emulsifiers include: isopropylamine dodecylbenzene sulfonates, such as Bio-Soft N-411; calcium dodecylbenzene sulfonates, such as Nansa® EVM 70/2E (Nansa® is a trademark of Innospec Performance Chemicals Europe Ltd, Cheshire, UK); sodium dioctyl sulfosuccinates, such as Geropon® SDS (Geropon® is a registered trademark of Rhodia Chimie SAS, Aubervilliers, France), Lankropol™ KPH 70 (Lankropol™ is a trademark of Nouryon Surface Chemistry LLC, Chicago, Illinois, USA), or Aerosol OT (Aerosol OT is available from Solvay S.A., Brussels, Belgium); or sodium lauryl sulfonates, such as Stepanol® ME Dry (Stepanol® is a registered trademark of Stepan Company, Northfield, Illinois, USA). Suitable polymeric emulsifiers include: EO/PO block copolymers, such as Toximul® 8320, Termul® 5500 (Termul® is a registered trademark of Indorama Ventures Oxides LLC, The Woodlands, Texas, USA), Ethylan™ NS-500LQ (Ethylan™ is a trademark of Nouryon Surface Chemistry LLC, Chicago, Illinois, USA), Tergitol® XD (Tergitol® is a registered trademark of Union Carbide Corporation, Midland, Michigan, USA), Pluronic® P-105 (Pluronic® is a registered trademark of BASF Corporation, Mount Olive, New Jersey, USA), or Atlas® G5002L (Atlas® is a registered trademark of Croda International Plc, Goole, East Yorkshire, UK); or other polymeric surfactants, such as Atlox® 4912 or Atlox® 4914. Suitable antifoam agents include polydimethylsiloxanes emulsified in water, such as Foamaster® UDB (Foamaster® is a registered trademark of Cognis IP Management GmbH, Düsseldorf, Germany), SAG® 1572, or SAG® 1599 (SAG® is a registered trademark of Momentive Performance Materials Inc., Waterford, New York, USA). Suitable built-in adjuvants include: methylated seed oils, including C₁₈ soyate and C₁₈ rapeate, such as Agnique® ME 18 RD-F, Agnique® ME 18 SD-F, Agnique® ME 2337, or Edenor® ME 12-18; non-ionic surfactants, including ethoxylated castor oils such as Agnique® CSO-25, Etocas™ 10, Etocas™ 29, or Etocas™ 40; ethoxylated fatty alcohols, such as Synperonic® 13/12; polysorbates, such as Tween® 80 (Tween® is a registered trademark of Croda International Plc, Goole, East Yorkshire, UK); sorbitan esters, such as Span® 80 (Span® is a registered trademark of Uniqema Americas LLC, Wilmington, Delaware, USA); and phosphates, such as tris-ethylhexyl phosphate.

Formulations comprising the pyridine carboxylate herbicides of the present disclosure may be oil-in-water emulsions, where the pyridine carboxylate herbicide is dissolved in the dispersed droplets of the organic liquid phase. The emulsion formation may contain: the organic liquid; an emulsifier; and water, an aqueous liquid, or other diluent. Suitable organic liquids and emulsifiers may be chosen from the solvents, cosolvents, and emulsifiers listed for emulsion concentrates. The emulsion formulation may also contain other ingredients, including but not limited to: an antimicrobial agent, a viscosity modifier, antifreeze, a pH modifier, an antifoam agent, or a built-in adjuvant. Suitable antimicrobial agents include: 1,2-benzisothiazolin-3-one, such as Proxel® GXL (Proxel® is a registered trademark of Arch UK Biocides Ltd, Castleford, West Yorkshire, UK); 5-chloro-2-methyl-4-isothiazolin-3-one; or 2-methyl4-isothiazolin-3-one, such as Kathon® CG/ICP (Kathon® is a registered trademark of Rohm and Haas Company, Philadelphia, Pennsylvania, USA). Suitable viscosity modifiers include: butene/isobutene co-polymers, such as Indopol® H-15 (Indopol® is a registered trademark of Ineos Oligomers USA LLC, League City, Texas, USA); smectite clay, such as Veegum® (Veegum® is a registered trademark of Vanderbilt Minerals LLC, Norwalk, Connecticut, USA); microcrystalline cellulose, such as Avicel® CL-611 (Avicel® is a registered trademark of DuPont Nutrition USA, Wilmington, Delaware, USA); xanthum gum, such as Rhodopol® 23, Rhodopol® Extra 2, or Rhodicare® CFT (Rhodopol® and Rhodicare® are registered trademarks of Rhodia Chimie Corporation, Aubervilliers, France); or diutan gum. Suitable antifreeze compounds include: propylene glycol; glycerol; or electrolyte-based antifreeze, such as sodium chloride or sodium acetate. Suitable pH modifiers include agriculturally-acceptable weak acidic or basic buffers, such as sodium phosphate, potassium phosphate, phosphoric acid, sodium citrate, potassium citrate, citric acid, sodium lactate, potassium lactate, or lactic acid. Suitable antifoam agents include polydimethylsiloxanes emulsified in water, such as Foamaster® UDB, SAG® 1572, or SAG® 1599. For diluents, water, an aqueous liquid, or a polar solvent that is not miscible with the organic phase can be selected. Suitable built-in adjuvants include: methylated seed oils, including C18 soyate and C18 rapeate, such as Agnique® ME 18 RD-F, Agnique® ME 18 SD-F, Agnique® ME 2337, or Edenor® ME 12-18; ethoxylated castor oils such as Agnique® CSO-25, Etocas™ 10, Etocas™ 29, or Etocas™ 40; ethoxylated fatty alcohols, such as Synperonic® 13/12; polysorbates, such as Tween® 80; sorbitan esters, such as Span® 80; or phosphates, such as tris-ethylhexyl phosphate.

Formulations comprising the pyridine carboxylate herbicides of the present disclosure may be microemulsions comprising an water-immiscible organic liquid phase (e.g., an oil phase) and a water-miscible phase. The pyridine carboxylate herbicide may be dissolved in the oil phase or the water-miscible phase. The microemulsion formulation may contain: a water immiscible organic liquid; water, an aqueous liquid, or a water-miscible solvent; and an emulsifier. Suitable water-immiscible organic liquids and emulsifiers may be chosen from the solvents, cosolvents, and emulsifiers listed for emulsion concentrates. Suitable water-miscible solvents include, but are not limited to, propylene carbonates, such as Jeffsol® AG 1555. The microemulsion formulation may also contain additional ingredients, including but not limited to: an antimicrobial agent, a pH modifier, an antifoam agent, or a built-in adjuvant. Examples of these ingredients are described above for oil-in-water emulsions.

### b) Suspensions

A suspension is a heterogeneous liquid formulation containing a finely-divided solid dispersed within a continuous liquid phase.

A suspension concentrate is a stable suspension of active ingredients with water or an aqueous liquid as the continuous liquid phase, intended for dilution with water or an aqueous liquid by the end user before use.

A capsule suspension is a stable suspension of capsules, such as microencapsulated solid or liquid herbicides or herbicide compositions, dispersed in a continuous liquid phase.

An oil dispersion is a stable suspension of herbicide in a water-immiscible organic liquid phase, intended for dilution with water by the end user before use.

Formulations comprising the pyridine carboxylate herbicides of the present disclosure may be suspension concentrates comprising a stable suspension of the powdered pyridine carboxylate herbicide in a water or aqueous liquid continuous phase. The suspension concentrate may contain ingredients including but not limited to: water, a wetting agent, a dispersant, a viscosity modifier, an antifoam agent, an antimicrobial agent, antifreeze, a pH modifier, or a built-in adjuvant. Suitable wetting agents include blends of octyl sulfosuccinate and sodium naphthalene, such as Morwet® EFW (Morwet® is a registered trademark of Nouryon Surface Chemistry LLC, Chicago, Illinois, USA), and alcohol ethoxylates, such as Synperonic® 13/12. Suitable dispersants include: condensed naphthalene formaldehydes, such as Morwet® D-425; EO/PO block copolymers, such as Pluronic® P-105; or comb polymers, such as Atlox® 4913. Suitable viscosity modifiers include: butene/isobutene co-polymers, such as Indopol® H-15; smectite clays, such as Veegum®; microcrystalline cellulose, such as Avicel® CL-611; xanthum gum, such as Rhodopol® 23, Rhodicare® CFT, or Rhodopol® Extra 2; or diutan gum. Suitable antifoam agents include polydimethylsiloxanes emulsified in water, such as Foamaster® UDB, SAG® 1572, or SAG® 1599. Suitable antimicrobial agents include: 1,2-benzisothiazolin-3-one, such as Proxel® GXL; 5-chloro-2-methyl-4-isothiazolin-3-one; and 2-methyl-4-isothiazolin-3-one, such as Kathon® CG/ICP. Suitable antifreeze agents include glycols, such as propylene glycol, or glycerol. Suitable pH modifiers include agriculturally-acceptable weak acidic or basic buffers, such as sodium phosphate, potassium phosphate, phosphoric acid, sodium citrate, potassium citrate, citric acid, sodium lactate, potassium lactate, or lactic acid. Suitable built-in adjuvants include: ethoxylated castor oils, such as Agnique® CSO-25, Etocas™ 10, Etocas™ 29, or Etocas™ 40; ethoxylated fatty alcohols, such as Synperonic® 13/12); polysorbates, such as Tween® 80; sorbitan esters, such as Span® 80; or phosphates, such as tris-ethylhexyl phosphate.

Formulations comprising the pyridine carboxylate herbicides of the present disclosure may be capsule suspensions comprising a stable suspension of microcapsules in a water or aqueous liquid continuous phase. The pyridine carboxylate herbicide may be encapsulated in the microcapsules. The capsule suspension formulation may contain ingredients including but not limited to: microcapsules, organic solvents, water or aqueous liquid, an emulsifier, a dispersant, a viscosity modifier or suspending aide, an antimicrobial agent, antifreeze, a pH modifier, or a built-in adjuvant. For the microcapsule, methylene diphenyl diisocyanate (such as PAPI 27) and a water soluble primary or secondary polyamine (such as ethylenediamine or diethylenetriamine) can be used to form the microcapsules. Suitable organic solvents include high flash-point aromatic solvents, such as Aromatic 100, Aromatic 150, Aromatic 150 ND, Aromatic 200, or Aromatic 200 ND (Aromatic solvents are available from ExxonMobil Chemical Company, Spring, TX, USA). Suitable emulsifiers include: poly(vinyl alcohol), such as Selvol® 205 (Selvol® is a registered trademark of Sekisui Specialty Chemicals America, Dallas, Texas, USA) or Gohsenol® GL3 (Gohsenol® is a registered trademark of Mitsubishi Chemical Corporation, Tokyo, Japan); alkylpolyglycosides, such as Agnique® PG 8107; alcohol ethoxylates, such as Tergitol® 15-S-7 or Tergitol® 15-S-9; EO-PO block copolymers, such as Pluronic® P-105; polymethylmethacrylate-PEG graft copolymers, such as Atlox® 4913; phosphate esters, such as Multitrope™ 1214 (Multitrope™ is a trademark of Croda International Plc, Goole, East Yorkshire, UK); sodium dioctyl sulfosuccinates such as Geropon® SDS; isopropylamine dodecylbenzene sulfonates, such as Bio-Soft® N-411 (Bio-Soft® is a registered trademark of Stepan Chemical Corporation, Northfield, Illinois, USA); or calcium dodecylbenzene sulfonates, such as Nansa® EVM 70/2E. Suitable dispersants include: sodium lignosulfonate, such as Kraftsperse® 25M (Kraftsperse® is a registered trademark of Ingevity South Carolina LLC, North Charleston, South Carolina, USA); sodium styrene acrylates, such as Atlox Metasperse® 500L (Atlox Metasperse® is a registered trademark of Croda International Plc, Goole, East Yorkshire, UK); acrylic copolymer sulfonates, such as Agrilan® 789 (Agrilan® is a registered trademark of Akzo Nobel Chemicals International B.V., Arnhem, Netherlands); comb polymers such as Atlox® 4913; or tristyrylphenol ethoxylates, such as Soprophor® FLK (Soprophor® is a registered trademark of Rhodia Chemie SAS, Aubervilliers, France). Suitable viscosity modifiers or suspending aides include: butene/isobutene co-polymers, such as Indopol® H-15; smectite clays, such as Veegum®; microcrystalline cellulose, such as Avicel® CL-611; xanthum gum, such as Rhodopol® 23, Rhodicare CFT, or Rhodopol® Extra 2; or diutan gum. Suitable antimicrobial agents include: 1,2-benzisothiazolin-3-one, such as Proxel® GXL; 5-chloro-2-methyl-4-isothiazolin-3-one; and 2-methyl4-isothiazolin-3-one, such as Kathon® CG/ICP. Suitable antifreeze agents include: glycols, such as propylene glycol; glycerol; or electrolyte-based antifreeze, such as sodium chloride, or sodium acetate. Suitable pH modifiers include agriculturally-acceptable weak acidic or basic buffers, such as sodium phosphate, potassium phosphate, phosphoric acid, sodium citrate, potassium citrate, citric acid, sodium lactate, potassium lactate, or lactic acid. Suitable built-in adjuvants include: ethoxylated castor oils, such as Agnique® CSO-25, Etocas™ 10, Etocas™ 29, or Etocas™ 40; ethoxylated fatty alcohols, such as Synperonic® 13/12); polysorbates, such as Tween® 80; sorbitan esters, such as Span® 80; or phosphates, such as tris-ethylhexyl phosphate.

Formulations comprising the pyridine carboxylate herbicides of the present disclosure may be oil dispersions comprising a stable suspension of the powdered pyridine carboxylate herbicide dispersed in an organic solvent. The oil dispersion formulation may contain ingredients including but rot limited to: an organic solvent or oil, a surfactant, a thickener, antifreeze, an antifoam agent, or a built-in adjuvant. Suitable organic solvents or oils include: high flash-point aromatic solvents, such as Aromatic 100, Aromatic 150, Aromatic 150 ND, Aromatic 200, or Aromatic 200 ND; aliphatic/paraffinic oils, such as Isopar® M or Exxsol® D130; methylated seed oils, including C18 soyate and C18 rapeate, such as Agnique® ME 18 RD-F, Agnique® ME 18 SD-F, Agnique® ME 2337, or Edenor® ME 12-18; or fatty acid or triglyceride esters, such as Steposol® SC or Stepan® 108. Suitable thickeners include: rheological modifiers of hydrophobic organoclay, such as Bentone® 34 (Bentone® is a registered trademark of Elementis Specialties, Inc., Hightstown, New Jersey, USA); oil-based polymers; or hydrophobic modified silica, such as Aerosil® R974 (Aerosil® is a registered trademark of Evonik Operations GmbH, Essen, Germany). Suitable surfactants include non-ionic polymeric surfactants, such as Pluronic® F-108 or Atlox® 4912. Suitable antifreeze agents include: glycols, such as propylene glycol; glycerol; or electrolyte-based antifreeze, such as sodium chloride, or sodium acetate. Suitable antifoam agents include polydimethylsiloxanes emulsified in water, such as Foamaster® UDB, SAG® 1572, or SAG® 1599. Suitable built-in adjuvants include: methylated seed oils, including C18 soyate and C18 rapeate, such as Agnique® ME 18 RD-F, Agnique® ME 18 SD-F, Agnique® ME 2337, or Edenor® ME 12-18; ethoxylated castor oils, such as Agnique® CSO-25, Etocas™ 10, Etocas™ 29, or Etocas™ 40; ethoxylated fatty alcohols, such as Synperonic® 13/12); polysorbates, such as Tween® 80; sorbitan esters, such as Span® 80; or phosphates, such as tris-ethylhexyl phosphate.

### c) Suspo-emulsions

A suspo-emulsion is a liquid, heterogeneous formulation consisting of a stable dispersion of active ingredient(s) in the form of solid particles and of an oil-in-water emulsion in a continuous water or aqueous liquid phase.

Formulations comprising the pyridine carboxylate herbicides of the present disclosure may be suspo-emulsions, where the pyridine carboxylate herbicide may be dissolved in the organic solvent as part of the oil-in-water emulsion, or dispersed as solid particles. The suspo-emulsion formation may contain the organic solvent, an emulsifier, and water or other diluent. Suitable organic solvents and emulsifiers may be chosen from the solvents, cosolvents, and emulsifiers listed for emulsion concentrates. Other suitable organic solvents include: high flash-point aromatic solvents, such as Aromatic 100, Aromatic 150, Aromatic 150 ND, Aromatic 200, or Aromatic 200 ND; or aliphatic/paraffinic oils, such as Isopar® M or Exxsol® D130. Suitable diluents include, but are not limited to, water or propylene carbonates, such as Jeffsol® AG 1555. The suspo-emulsion formulation may also contain a wetting agent, a dispersant, a viscosity modifier, an antifoam agent, an antimicrobial agent, antifreeze, a pH modifier, or a built-in adjuvant. Suitable wetting agents include: blend of octyl sulfosuccinate and sodium naphthalene, such as Morwet® EFW; EO/PO block polymers, such as Pluronic® P-105; alcohol ethoxylates, such as Synperonic® 13/12; sodium taurates, such as Geropon® T-77; or polycarboxylates, such as Geropon® T-36. Suitable dispersants include: sodium naphthalene sulfonate formaldehyde condensates, such as Morwet® D-425; EO-PO block copolymers, such as Pluronic®-105; or comb copolymers, such as Atlox® 4913. Suitable viscosity modifiers include: butene/isobutene co-polymers, such as Indopol® H-15; smectite clays, such as Veegum®; microcrystalline cellulose, such as Avicel® CL-611; xanthum gum, such as Rhodopol® 23, Rhodicare® CFT, or Rhodopol® Extra 2; or diutan gum. Suitable antifoam agents include polydimethylsiloxanes emulsified in water, such as Foamaster® UDB, SAG® 1572, or SAG® 1599. Suitable antimicrobial agents include: 1,2-benzisothiazolin-3-one, such as Proxel® GXL; 5-chloro-2-methyl-4-isothiazolin-3-one; and 2-methyl4-isothiazolin-3-one, such as Kathon® CG/ICP. Suitable antifreeze agents include: glycols, such as propylene glycol; glycerol; or electrolyte-based antifreeze, such as sodium chloride, or sodium acetate. Suitable pH modifiers include agriculturally-acceptable weak acidic or basic buffers, such as sodium phosphate, potassium phosphate, phosphoric acid, sodium citrate, potassium citrate, citric acid, sodium lactate, potassium lactate, or lactic acid. Suitable built-in adjuvants include: ethoxylated castor oils, such as Agnique® CSO-25, Etocas™ 10, Etocas™ 29, or Etocas™ 40; ethoxylated fatty alcohols, such as Synperonic® 13/12; polysorbates, such as Tween® 80; sorbitan esters, such as Span® 80; or phosphates, such as tris-ethylhexyl phosphate.

### d) Soluble Liquid Formulations

A soluble liquid formulation is a stable, clear to opalescent liquid containing a solution of the active ingredient, where the active ingredient remains in solution after dilution in water. The soluble liquid formulation may contain water-insoluble ingredients. Soluble liquid formulations may be concentrates, where the concentrate is diluted with water by the end user prior to use.

Formulations comprising the pyridine carboxylate herbicides of the present disclosure may be soluble liquid formulations, where the pyridine carboxylate herbicide may be dissolved in a diluent. The soluble liquid formulation may contain additional ingredients including but not limited to: a salt counter ion, a wetting agent, an antifoam agent, an antifreeze, a sequestrant or dispersant agent, a diluent, or a built-in adjuvant. Suitable salt counter ions include: various bases, such as potassium hydroxide or sodium hydroxide; or various amines, such as dimethylamine (DMA), triisopropanolamine (TIPA), monoethanolamine (MEA), or 2-hydroxyethyl(trimethylammonium (choline). Suitable wetting agents include EO/PO block polymeric ethers such as Polyglycol 26-2 or Polyglycol 26-2N (Polyglycol 26-2 or 26-2N may be obtained from the Dow Chemical Company, Midland, Michigan, USA). Suitable antifoam agents include polydimethylsiloxanes emulsified in water, such as Foamaster® UDB, SAG® 1420, or SAG® 1599. Suitable antifreeze agents include: glycols, such as propylene glycol; glycerol; or electrolyte-based antifreeze, such as sodium chloride, or sodium acetate. Suitable sequestrants or dispersants include polyaminocarboxylic acid-lignosulphonates, such as EDTA-lignosulphonates. Suitable diluents include: water or propylene carbonate, such as Jeffsol® AG 1555. Suitable built-in adjuvants include: ethoxylated castor oils, such as Agnique® CSO-25, Etocas™ 10, Etocas 29™, or Etocas™ 40; ethoxylated fatty alcohols, such as Synperonic® 13/12); polysorbates, such as Tween® 80; sorbitan esters, such as Span® 80; or phosphates, such as tris-ethylhexyl phosphate.

### e) Concentrates

In various aspects, the formulation may be provided as a high-strength formulation such as a concentrate. In some aspects, the concentrate is stable and retains potency during storage and shipping. In various aspects, the concentrate is a clear, homogeneous liquid that is stable at temperatures of 54° C. or greater. In some aspects, the concentrate does not exhibit any precipitation of solids at temperatures of −10° C. or lower. In some aspects, the concentrate does not exhibit separation, precipitation, or crystallization of any components at low temperatures. For example, the concentrate remains a clear solution at temperatures below 0° C. (e.g., below −5° C., below −10° C., or below −15° C.). In some aspects, the concentrate exhibits a viscosity of less than 50 centipoise (50 megapascals), even at temperatures as low as 5° C. In some aspects, the concentrate does not exhibit separation, precipitation, or crystallization of any components during storage for a period of 2 weeks or greater (e.g., 4 weeks, 6 weeks, 8 weeks, 3 months, 6 months, 9 months, or 12 months or greater).

ii. Solid and Semi-solid Formulations

In some aspects, the formulation is a solid or semi-solid. The solid or semi-solid formulation may be in the form of powders, granules, tablets, briquettes, gels, pastes, or greases. The solid or semi-solid formulations may be mixed with water by the end user before use, or the solid or semi-solid formulations may be applied directly as solids by the end user.

### a) Powders

Powders are free-flowing, finely divided solid formulations. Dustable powders are free-flowing powders suitable for dusting onto soil, water, or directly upon undesirable vegetation where control of undesirable vegetation is desired. Emulsifiable powders are powder formulations, which may contain water-insoluble ingredients, to be applied as an oil-in-water emulsion of the active ingredients after dispersion in water or an aqueous liquid. An oil dispersible powder is a powder formulation to be applied as a suspension after dispersion in an organic liquid. A water soluble powder is a powder formulation to be applied as a true solution of the active ingredient after dissolution in water or an aqueous liquid, but which may contain insoluble inert ingredients. A wettable powder is a powder formulation to be applied as a suspension after dispersion in water or an aqueous liquid. A water dispersible powder for slurry treatment is a powder to be dispersed at a high concentration in water or an aqueous liquid before application as a slurry. Powders may also be applied onto soil, water, or directly upon undesirable vegetation where control of undesirable vegetation is desired.

### b) Granules

Granules are a free-flowing solid formulation of particles that are larger than powders, where the particles are of a defined size range. Typical granules may be roughly spheroid, cuboid, or cylindrical in shape, with sizes ranging from about 0.3 mm to about 1 cm in diameter or side. A water soluble granule is a granular formulation containing granules to be applied as a true solution of the active ingredient after dissolution in water or an aqueous liquid, but which may contain insoluble inert ingredients. An emulsifiable granule is a granular formulation, which may include water-insoluble ingredients, which is applied as an oil-in-water emulsion of the active ingredient after disintegration in water or an aqueous liquid. A wettable granule is a granular formulation to be applied as a suspension after the granule is dispersed in water or an aqueous liquid. Granules can also be applied directly to the soil or water where control of undesirable vegetation is desired.

Formulations comprising the pyridine carboxylate herbicides of the present disclosure may be wettable granules, where the pyridine carboxylate herbicide is incorporated in the granule as a solid material. The wettable granule formulation may contain additional ingredients, including but not limited to: a wetting agent, a dispersing agent, a binding agent, a disintegrating agent or processing aid, a filler or solid diluent, a pH modifier, or an antifoam agent. Suitable wetting agents include: blends of octyl sulfosuccinate and sodium naphthalene, such as Morwet® EFW; or sodium lauryl sulfonates, such as Stepanol® ME Dry. Suitable dispersing and binding agents include: sodium lignosulfonates, such as Kraftsperse® 25M or Polyfon® (Polyfon® is a registered trademark of Ingevity South Carolina, North Charleston, South Carolina, USA); or condensed naphthalene formaldehydes, such as Morwet® D-425. Suitable disintegrating agents or processing aids include: polymethyl urea resins, such as Pergopak® M (Pergopak® is a registered trademark of Martinswerk GmbH, Bergheim, Germany), or lactose/corn starch granulation compositions. Suitable fillers or solid diluents include: organoclays, such as kaolin or bentonite; or lactose monohydrates. Suitable pH modifiers include agriculturally-acceptable weak acidic or basic buffers, such as sodium phosphate, potassium phosphate, phosphoric acid, sodium citrate, potassium citrate, citric acid, sodium lactate, potassium lactate, or lactic acid. Suitable antifoam agents include powder defoamers such as Agnique® Soap L.

### c) Tablets

Tablets are dry formulations that are typically in pre-formed and pre-measured solid units of uniform shape and dimensions, often disk-shaped, with either flat or convex faces, where the distance between faces is less than the diameter of the tablet. Tablets for direct application are tablet formulations that can be applied individually and directly in the soil or bodies of water, without being incorporated into a spraying solution or dispersion. Water soluble tablets are tablet formulations that are used individually to form a solution of the active ingredient after the tablet is disintegrated in water or an aqueous liquid. Water dispersible tablets are tablet formulations that are used individually to form a dispersion of the active ingredient after the tablet is disintegrated in water or an aqueous liquid.

### d) Briquettes

Briquettes are dry formulations in the form of solid blocks, for controlled release of the active ingredient into water.

### e) Semi-solid Pastes, Gels, or Greases

Semi-solid formulations may be in the form of pastes, gels, or greases. A gel is a formulation where in the active ingredient is suspended or dissolved in a plastic, typically gelatinous, semi-solid. A paste is a water-based film-forming composition. A grease is a very viscous formulation where the active ingredient is suspended or dissolved in an oil or fat. A gel or paste concentrate is a solid formulation to be applied as a gel or paste after dilution with water or an aqueous liquid. An emulsifiable gel, paste, or grease is a formulation to be diluted with water or an aqueous liquid to form an emulsion. A water soluble gel is a formulation to be dissolved in water or an aqueous liquid and applied as an aqueous solution. A gel, paste, or grease may be applied directly without dilution.

In some aspects, powders, materials for spreading, or dusts can be prepared by mixing or concomitant grinding of the pyridine carboxylate herbicide and optionally other additives with a solid carrier. In some aspects, granules (e.g., coated granules, impregnated granules and homogeneous granules) can be prepared by binding the pyridine carboxylate herbicide and optionally other additives with solid carriers. In some aspects, the granules may be prepared using an extrusion process.

iii. Formulation Properties

In some aspects, the formulations comprise, in weight percent based on the total weight of the formulation, from about 1% to about 99% of the pyridine carboxylate herbicide (e.g., about 1.5%, 2%, 2.5%, 3%, 4%, 5%, 6%, 7%, 7.5%, 8%, 9%, 10%, 12.5%, 15%, 17.5%, 20%, 25%, 20%, 25%, 30%, 35%, 40%, 45%, 50%, 55%, 60%, 65%, 70%, 75%, 80%, 82.5%, 85%, 87.5%, 90%, 92.5%, or 95% of the pyridine carboxylate herbicide), or within any range defined from any two of the forgoing values, such as from about 1% to about 95%, from about 10% to about 60%, from about 20% to about 45%, from about 55% to about 82.5%, or from about 12.5% to about 50% of the pyridine carboxylate herbicide, by weight percent based on the total weight of the formulation.

In some aspects, the liquid concentrate formulations comprise, in grams active ingredient per liter (g ai/L) of the formulation, a concentration from about 1 g ai/L to about 500 g ai/L of the pyridine carboxylate herbicide (e.g., about 1.5, 2, 2.5, 3, 4, 5, 6, 7, 7.5, 8, 9, 10, 12.5, 15, 17.5, 20, 25, 30, 35, 40, 45, 50, 60, 70, 75, 80, 90, 100, 110, 112, 115, 117, 120, 125, 130, 140, 150, 160, 170, 175, 180, 190, 200, 210, 215, 220, 225, 230, 240, 250, 275, 300, 325, 350, 375, 400, 425, 450, or 475 g ai/L of the pyridine carboxylate herbicide), or within any range defined from any two of the forgoing values, such as from about 1 g ai/L to about 450 g ai/L, from about 100 g ai/L to about 350 g ai/L, from about 20 g ai/L to about 150 g ai/L, or from about 112 g ai/L to about 250 g ai/L of the pyridine carboxylate herbicide.

In some aspects, the solid formulations comprise, in grams active ingredient per kilogram (g ai/kg) of the formulation, a concentration from about 1 g ai/kg to about 500 g ai/kg of the pyridine carboxylate herbicide (e.g., about 1.5, 2, 2.5, 3, 4, 5, 6, 7, 7.5, 8, 9, 10, 12.5, 15, 17.5, 20, 25, 30, 35, 40, 45, 50, 60, 70, 75, 80, 90, 100, 110, 112, 115, 117, 120, 125, 130, 140, 150, 160, 170, 175, 180, 190, 200, 210, 215, 220, 225, 230, 240, 250, 275, 300, 325, 350, 375, 400, 425, 450, or 475 g ai/kg of the pyridine carboxylate herbicide), or within any range defined from any two of the forgoing values, such as from about 10 g ai/kg to about 400 g ai/kg, from about 100 g ai/kg to about 350 g ai/kg, from about 200 g ai/kg to about 250 g ai/kg, or from about 125 g ai/kg to about 300 g ai/kg of the pyridine carboxylate herbicide.

In a formulation designed to be employed as a concentrate, the concentrate can be diluted with an diluting solvent, such as water or an aqueous liquid, to form a tank mix prior to application. The tank mix applied to undesirable vegetation or the locus of undesirable vegetation can contain from about 0.006 to about 100 g ai/L of the pyridine carboxylate herbicide (e.g., about 0.01, 0.05, 0.1, 0.25, 0.5, 0.75, 1, 1.5, 2, 2.5, 5, 7.5, 10, 11, 12, 12.5, 13, 14, 15, 16, 17, 17.5, 18, 19, 20, 22, 22.5, 24, 25, 26, 27.5, 28, 30, 32, 32.5, 34, 35, 36, 37.5, 38, 40, 42, 44, 45, 46, 48, 50, 52.5, 55, 57.5, 60, 62.5, 65, 67.5, 70, 72.5, 75, 77.5, 80, 82.5, 85, 87.5, 90, 92.5, 95, 97.5, or 99 g ai/L of pyridine carboxylate herbicide), or within any range defined from any two of the forgoing values, such as from about 0.01 g ai/L to about 30 g ai/L, about 7.5 g ai/L to about 25 g ai/L, about 7.5 g ai/L to about 75 g ai/L, about 15 g ai/L to about 95 g ai/L, or about 0.25 g ai/L to about 5 g ai/L of the pyridine carboxylate herbicide in the tank mix.

iv. Formulation Stability

Formulations comprising the pyridine carboxylate herbicides of the present disclosure may sometimes be found to be unstable. Formulation instability may be due to chemical instability of one or more ingredients in the formulation. Formulation instability may also be due to physical instability, due to the separation, precipitation, coagulation, gelling, or other physical change to the formulation. Formulation instability may occur: a) immediately after the formulation is prepared; b) within a short period of time after the formulation is prepared, such as within hours, days, or weeks of preparation; or c) after the formulation is stored for a long period of time, such as weeks, months, or years after preparation. Formulation instability may occur when the formulation is exposed to temperature extremes, such as cold temperatures (e.g., at temperatures of about less than −40 C, −40 C, −35 C, −30 C, −25 C, −20 C, −15 C, −10 C, −5 C, or 0 C) or hot temperatures (e.g., at temperatures of about 35 C, 40 C, 45 C, 50 C, 55 C, 60 C, or 65 C or greater.) Formulation instability may occur when the formulation is stored for a period of time (e.g., days, weeks, months, or years) at cold temperatures, hot temperatures, or at temperatures that vary between cold and hot over time.

The formulations disclosed herein may be unstable due to the chemical instability or degradation of one or more ingredients in the formulation.

In some aspects, the formulations may be unstable due to chemical instability in a solvent or carrier used to prepare the formulation. For example, formulations are discussed below where the pyridine carboxylate herbicides of the present disclosure are unstable in certain agriculturally-acceptable solvents. In other aspects, other ingredients or additives in the formulation may be unstable in a solvent or carrier used to prepare the formulation. For example, it is known that triazolpyrimidine herbicides, such as pyroxsulam, penoxsulam, and florasulam, may be chemically unstable in certain agriculturally-acceptable nitrogen-containing solvents, such as N,N-dimethyl lactamide or n-butyl pyrrolidone. For this reason, it is typically preferred that solvents or carriers are selected that cause limited or no chemical instability of herbicides, additives, or other ingredients in the formulation.

In some aspects, the formulations may be unstable due to chemical instability at certain PH levels in liquid or semi-liquid formulations. In some aspects, some herbicides may be unstable at acidic, neutral, or basic pH levels in liquid or semi-liquid formulations. In some aspects, some additives may be unstable at acidic, neutral, or basic pH levels in liquid or semi-liquid formulations. In some aspects, some other ingredients may be unstable at acidic, neutral, or basic pH levels in liquid or semi-liquid formulations. For example, florasulam, flumioxazin, and paraquat may be unstable at basic pH levels in liquid formulations, such as emulsifiable concentrates, oil-in-water emulsions, water-in-oil emulsions, microemulsions, suspensions, suspension concentrates, suspoemulsions, oil dispersions, and soluble liquid formulations. In some aspects, formulations may contain buffering agents to maintain the pH of the formulation at a level that maintain the chemical stability of the herbicides, additives, and other ingredients in the formulations. Examples of buffering agents that can be used in formulations include: weak acids, such as citric acid, acetic acid, lactic acid, oxalic acid, cloquintocet acid, tartaric acid, and agriculturally acceptable salts thereof; and weak bases, such as borax, bicarbonate, phosphate, ammonia, and agriculturally acceptable salts thereof.

In some aspects, the formulations may be unstable due to physical instability or incompatibility of the ingredients in liquid or semi-liquid formulations. In some aspects, the physical instability may result in one or more incompatible ingredients precipitating, coagulating, gelling, or undergoing phase separation in the formulation. For example, it is known that cloquintocet-mexyl, a commonly-used safener to protect cereal crops from herbicidal damage, may become physically unstable and crystallize or precipitate in aqueous formulations. Crystals of cloquintocet-mexyl may be hard to re-solubilize or suspend in a tank mix, and the crystals may clog the nozzles or filters of the equipment used to apply a tank mix to a crop. It is also known that certain salt forms of 2,4-D and glyphosate will precipitate when these herbicides are formulated in a concentrated liquid formulation. The precipitates may coalesce into a bonded or solidified mass which can be difficult or impossible to resuspend or dissolve when the concentrated formulation is diluted. Physical instability or incompatibility can be difficult to solve in a single formulation. In some aspects, physical instability can be solved by multi-package formulations, such as a two-package formulation, where the incompatible ingredients are packaged separately and only mixed together, with sufficient dilution, in the tank mix prior to use. In some aspects, physical instability can be solved by careful selection of the chemical form (e.g., the counter-ion in a salt form, or the ester in an ester form) that will permit the ingredients to be mixed without physical instability. In some aspects, physical instability can be solved by adding additional ingredients, such as organic solvents or surfactants, that maintain all ingredients in a soluble or suspended form.

### B. Additives

The formulations disclosed herein can also comprise one or more additives, such as the additives described previously. In some aspects, the additive is premixed with the pyridine carboxylate herbicide. In some aspects, the additive is added sequentially. In some aspects, the additive is added simultaneously.

i. Other Pesticides

Some aspects of the described herbicidal formulations includes adding one or more additional pesticide active ingredients to the herbicidal formulations. These pesticide active ingredients may include one or more of an herbicide, an insecticide, a fungicide, a nematocide, a miticide, a arthropodicide, a bactericide, a plant growth regulator, or combinations thereof that are compatible with the formulations of the present disclosure.

In some aspects, the additive is an additional herbicide. The formulation can contain one or more additional herbicides, be tank mixed with the one or more additional herbicides, or applied sequentially with the one or more additional herbicides. Exemplary additional herbicides include, but are not limited to: 4-CPA; 4-CPB; 4-CPP; 2; 4-D; 2; 4-D choline salt; 2,4-D salts, esters and amines; 2,4-DB; 3,4-DA; 3,4-DB; 2,4-DEB; 2,4-DEP; 2,4-DP; 3,4-DP; 2,3,6-TBA; 2,4,5-T; 2,4,5-TB; acetochlor; acifluorfen; aclonifen; acrolein; alachlor; allidochlor; alloxydim; allyl alcohol; alorac; ametridione; ametryne; amibuzin; amicarbazone; amidosulfuron; aminocyclopyrachlor; 4-aminopicolinic acid based herbicides, such as halauxifen, halauxifen-methyl, florpyrauxifen, and florpyrauxifen-benzyl; aminopyralid; amiprofos-methyl; amitrole; ammonium sulfamate; anilofos; anisuron; asulam; atraton; atrazine; azafenidin; azimsulfuron; aziprotryne; barban; BCPC; beflubutamid; benazolin; bencarbazone; benfluralin; benfuresate; bensulide; bensulfuron; benthiocarb; bentazone; benzadox; benzfendizone; benzipram; benzobicyclon; benzofenap; benzofluor; benzoylprop; benzthiazuron; bilanafos; bicyclopyrone; bifenox; bilanafos; bipyrazone; bispyribac; bixlozone; borax; bromacil; bromobonil; bromobutide; bromofenoxim; bromoxynil; brompyrazon; butachlor; butafenacil; butamifos; butenachlor; buthidazole; buthiuron; butralin; butroxydim; buturon; butylate; cacodylic acid; cafenstrole; calcium chlorate; calcium cyanamide; cambendichlor; carbasulam; carbetamide; carboxazole; chlorprocarb; carfentrazone-ethyl; CDEA; CEPC; chlomethoxyfen; chloramben; chloranocryl; chlorazifop; chlorazine; chlorobromuron; chlorbufam; chloreturon; chlorfenac; chlorfenprop; chlorflurazole; chlorflurenol; chloridazon; chlorimuron; chlornitrofen; chloropon; chlorotoluron; chloroxuron; chloroxynil; chlorpropham; chlorsulfuron; chlorthal; chlorthiamid; cinidon-ethyl; cinmethylin; cinosulfuron; cisanilide; clacyfos; clethodim; cliodinate; clodinafop-propargyl; clofop; clomazone; clomeprop; cloprop; cloproxydim; clopyralid; clopyralid-olamine; cloransulam-methyl; CMA; copper sulfate; CPMF; CPPC; credazine; cresol; cumyluron; cyanatryn; cyanazine; cycloate; cyclopyranil; cyclopyrimorate; cyclosulfamuron; cycloxydim; cycluron; cyhalofop-butyl; cyperquat; cyprazine; cyprazole; cypromid; daimuron; dalapon; dazomet; delachlor; desmedipham; desmetryn; di-allate; dicamba; dichlobenil; dichloralurea; dichlormate; dichlorprop; dichlorprop-P; diclofop-methyl; diclosulam; diethamquat; diethatyl; difenopenten; difenoxuron; difenzoquat; diflufenican; diflufenzopyr; dimefuron; dimepiperate; dimethachlor; dimethametryn; dimethenamid; dimethenamid-P; dimexano; dimidazon; dinitramine; dinofenate; dinoprop; dinosam; dinoseb; dinoterb; diphenamid; dipropetryn; diquat; disul; dithiopyr; diuron; DMPA; DNOC; DSMA; EBEP; eglinazine; endothal; epronaz; EPTC; erbon; esprocarb; ethalfluralin; ethametsulfuron; ethbenzamide; ethametsulfuron; ethidimuron; ethiolate; ethobenzamid; ethofumesate; ethoxyfen; ethoxysulfuron; etinofen; etnipromid; etobenzanid; EXD; fenasulam; fenoprop; fenoxaprop; fenoxaprop-P-ethyl; fenoxaprop-P-ethyl+isoxadifen-ethyl; fenoxasulfone; fenquinotrione; fenteracol; fenthiaprop; fentrazamide; fenuron; ferrous sulfate; flamprop; flamprop-M; flazasulfuron; florpyrauxifen; florpyrauxifen-benzyl; florasulam; fluazifop; fluazifop-P-butyl; fluazolate; flucarbazone; flucetosulfuron; fluchloralin; flufenacet; flufenican; flufenpyr-ethyl; flumetsulam; flumezin; flumiclorac-pentyl; flumioxazin; flumipropyn; fluometuron; fluorodifen; fluoroglycofen; fluoromidine; fluoronitrofen; fluothiuron; flupoxam; flupropacil; flupropanate; flupyrsulfuron; fluridone; flurochloridone; fluroxypyr; fluroxypyr-meptyl; flurtamone; fluthiacet; fomesafen; foramsulfuron; fosamine; fumiclorac; furyloxyfen; glufosinate; glufosinate-ammonium; glufosinate-P-ammonium; glyphosate salts and esters; halauxifen; halauxifen-methyl; halosafen; halosulfuron; haloxydine; haloxyfop; hexachloroacetone; hexaflurate; hexazinone; imazamethabenz; imazamox; imazapic; imazapyr; imazaquin; imazethapyr; imazosulfuron; indanofan; indaziflam; iodobonil; iodomethane; iodosulfuron; iodosulfuron-ethyl-sodium; iofensulfuron; ioxynil; ipazine; ipfencarbazone; iprymidam; isocarbamid; isocil; isomethiozin; isonoruron; isopolinate; isopropalin; isoproturon; isouron; isoxaben; isoxachlortole; isoxaflutole; isoxapyrifop; karbutilate; ketospiradox; lactofen; lenacil; linuron; MAA; MAMA; MCPA; MCPA esters and amines; MCPA-thioethyl; MCPB; mecoprop; mecoprop-P; medinoterb; mefenacet; mefluidide; mesoprazine; mesosulfuron; mesotrione; metam; metamifop; metamitron; metazachlor; metflurazon; methabenzthiazuron; methalpropalin; methazole; methiobencarb; methiozolin; methiuron; methometon; methoprotryne; methyl bromide; methyl isothiocyanate; methyldymron; metobenzuron; metobromuron; metolachlor; metosulam; metoxuron; metribuzin; metsulfuron; molinate; monalide; monisouron; monochloroacetic acid; monolinuron; monuron; morfamquat; MSMA; naproanilide; napropamide; napropamide-M; naptalam; neburon; nicosulfuron; nipyraclofen; nitralin; nitrofen; nitrofluorfen; norflurazon; noruron; OCH; orbencarb; ortho-dichlorobenzene; orthosulfamuron; oryzalin; oxadiargyl; oxadiazon; oxapyrazon; oxasulfuron; oxaziclomefone; oxyfluorfen; paraflufen-ethyl; parafluron; paraquat; pebulate; pelargonic acid; pendimethalin; penoxsulam; pentachlorophenol; pentanochlor; pentoxazone; perfluidone; pethoxamid; phenisopham; phenmedipham; phenmedipham-ethyl; phenobenzuron; phenylmercury acetate; picloram; picolinafen; pinoxaden; piperophos; potassium arsenite; potassium azide; potassium cyanate; pretilachlor; primisulfuron; procyazine; prodiamine; profluazol; profluralin; profoxydim; proglinazine; prohexadione-calcium; prometon; prometryne; pronamide; propachlor; propanil; propaquizafop; propazine; propham; propisochlor; propoxycarbazone; propyrisulfuron; propyzamide; prosulfalin; prosulfocarb; prosulfuron; proxan; prynachlor; pydanon; pyraclonil; pyraflufen; pyrasulfotole; pyrazogyl; pyrazone; pyrazolynate; pyrazosulfuron; pyrazoxyfen; pyribenzoxim; pyributicarb; pyriclor; pyridafol; pyridate; pyriftalid; pyriminobac; pyrimisulfan; pyrithiobac-sodium; pyroxasulfone; pyroxsulam; quinclorac; quinmerac; quinoclamine; quinonamid; quizalofop; quizalofop-P-ethyl; quizalofop-P-tefuryl; rhodethanil; rimsulfuron; saflufenacil; S-metolachlor; sebuthylazine; secbumeton; sethoxydim; siduron; simazine; simeton; simetryn; SMA; sodium arsenite; sodium azide; sodium chlorate; sulcotrione; sulfallate; sulfentrazone; sulfometuron; sulfosate; sulfosulfuron; sulfuric acid; sulglycapin; swep; TCA; tebutam; tebuthiuron; tefuryltrione; tembotrione; tepraloxydim; terbacil; terbucarb; terbuchlor; terbumeton; terbuthylazine; terbutryne; tetrafluron; thenylchlor; thiameturon; thiazafluron; thiazopyr; thidiazimin; thidiazuron; thiencarbazone; thifensulfuron; thiobencarb; tiafenacil; tiocarbazil; tioclorim; tolpyralate; topramezone; tralkoxydim; tri-allate; triafamone; triasulfuron; triaziflam; tribenuron; tribenuron; tricamba; triclopyr choline salt; triclopyr esters and amines; tridiphane; trietazine; trifloxysulfuron; trifludimoxazin; trifluralin; triflusulfuron; trifop; trifopsime; trihydroxytriazine; trimeturon; tripropindan; tritac; tritosulfuron; vernolate; xylachlor; and salts, esters, optically active isomers, and mixtures thereof. In some aspects, preferred herbicidal active ingredients in addition to the pyridine carboxylate herbicide include halauxifen, florasulam, penoxsulam, pyroxsulam, clopyralid, florpyrauxifen, triclopyr, cinmethylin, 2,4-D, MCPA, dicamba, glyphosate, glufosinate, agriculturally acceptable N-oxides, salts, or esters thereof, and mixtures thereof.

In some aspects, the formulations may include one or more herbicidal active ingredients in addition to the pyridine carboxylate herbicide. In some aspects, the formulations do not include an herbicidal active ingredient in addition to the pyridine carboxylate herbicide. In some aspects, the formulations may exclude one or more herbicidal active ingredients specified above. In some aspects, the formulations may include one or more herbicidal active ingredients in addition to the pyridine carboxylate herbicide, but may exclude one or more herbicidal ingredients specified above.

ii. Safeners

In some aspects, the additive is a safener. Safeners are compounds leading to better crop plant compatibility when applied with a herbicide. In some aspects, the safener itself is herbicidally active. In some aspects, the safener acts as an antidote or antagonist in the crop plants and can protect the crop plants from damage that might otherwise occur from an applied herbicide. Exemplary safeners include, but are not limited to, AD-67 (MON 4660), benoxacor, benthiocarb, brassinolide, cloquintocet, cloquintocet-mexyl, cyometrinil, cyprosulfamide, daimuron, dichlormid, dicyclonon, dietholate, dimepiperate, disulfoton, fenchlorazole, fenchlorazole-ethyl, fenclorim, flurazole, fluxofenim, furilazole, harpin proteins, isoxadifen-ethyl, jiecaowan, jiecaoxi, mefenpyr, mefenpyr-diethyl, mephenate, naphthalic anhydride, 2,2,5-trimethyl-3-(dichloroacetyl)-1,3-oxazolidine, 4-(dichloroacetyl)-1-oxa-4-azaspiro[4.5]decane, oxabetrinil, R29148, and N-phenyl-sulfonylbenzoic acid amides, as well as thereof agriculturally acceptable salts and, provided they have a carboxyl group, their agriculturally acceptable derivatives.

In some aspects, the safener can be cloquintocet or an ester or salt or ester thereof, such as cloquintocet-mexyl. In some aspects, the safener can be mefenpyr or an ester or salt thereof, such as mefenpyr-diethyl. In some aspects, the safener is employed in rice, cereal, or maize. For example, mefenpyr or cloquintocet can be used to antagonize harmful effects of the formulations on rice, row crops, and cereals.

It is known that when dry formulations, such as powders or granules, contain cloquintocet-mexyl, the cloquintocet-mexyl may readily convert to its hydrate form when the dry formulation is added to water or an aqueous liquid. Cloquintocet-mexyl hydrate tends to form large crystals, which can interfere with effective spraying of the herbicide composition. For this reason, a crystal inhibitor, such as a polycarboxylate, may be added to the dry formulation. A suitable polycarboxylate may be found in such products as Geropon® T-36.

iii. Adjuvants

In some aspects, the additive includes an agriculturally acceptable adjuvant. Exemplary agriculturally acceptable adjuvants include, but are not limited to, antifreeze agents, antifoam agents, compatibilizing agents, sequestering agents, neutralizing agents and buffers, pH modifiers, corrosion inhibitors, colorants, odorants, penetration aids, wetting agents, spreading agents, dispersing agents, thickening agents, flow aids, anti-caking agents, crystallization inhibitors, antimicrobial agents, crop oil, adhesives, surfactants, protective colloids, emulsifiers, tackifiers, and mixtures thereof.

Exemplary agriculturally acceptable adjuvants include, but are not limited to, crop oil concentrates (e.g., 85% mineral oil+15% emulsifiers); nonylphenol ethoxylates; benzylcocoalkyldimethyl quaternary ammonium salts; blends of petroleum hydrocarbon, alkyl esters, organic acids, and anionic surfactants; C₉-C₁₁ alkylpolyglycoside; phosphate alcohol ethoxylates; natural primary alcohol (C₁₂-C₁₆) ethoxylate; di-sec-butylphenol EO-PO block copolymers; polysiloxane-methyl cap; nonylphenol ethoxylateturea ammonium nitrates; emulsified methylated seed oils; tridecyl alcohol (synthetic) ethoxylates (e.g., 8 EO); tallow amine ethoxylates (e.g., 15 EO); and PEG (400) dioleate-99.

Exemplary surfactants (e.g., wetting agents, tackifiers, dispersants, emulsifiers) include, but are not limited to: the alkali metal salts, alkaline earth metal salts and ammonium salts of fatty acids or of aromatic sulfonic acids (e.g., lignosulfonic acids, phenolsulfonic acids, naphthalenesulfonic acids, and dibutylnaphthalenesulfonic acid); alkyl- and alkylarylsulfonates; alkyl sulfates, lauryl ether sulfates and fatty alcohol sulfates; salts of sulfated hexa-, hepta- and octadecanols; salts of fatty alcohol glycol ethers; condensates of sulfonated naphthalene and its derivatives with formaldehyde; condensates of naphthalene or of the naphthalene sulfonic acids with phenol and formaldehyde; polyoxyethylene octylphenol ether; ethoxylated isooctyl-, octyl- or nonylphenol, alkylphenyl or tributylphenyl polyglycol ether; alkyl aryl polyether alcohols; isotridecyl alcohol; fatty alcohol/ethylene oxide condensates; ethoxylated castor oil; polyoxyethylene alkyl ethers or polyoxypropylene alkyl ethers; lauryl alcohol polyglycol ether acetate; sorbitol esters; lignosulfite waste liquors and proteins; denatured proteins, polysaccharides (e.g., methylcellulose); hydrophobically modified starches; and polyvinyl alcohol, polycarboxylates, polyalkoxylates, polyvinyl amine, polyethyleneimine, polyvinylpyrrolidone, and copolymers thereof.

Exemplary thickeners include, but are not limited to, polysaccharides (e.g., xanthan gum), organic and inorganic sheet minerals, and mixtures thereof.

Exemplary antifoam agents include, but are not limited to, silicone emulsions, long-chain alcohols, fatty acids, fatty acid salts, organofluorine compounds, and mixtures thereof.

Exemplary antimicrobial agents include, but are not limited to: bactericides based on dichlorophen and benzyl alcohol hemiformal; isothiazolinone derivatives, such as alkylisothiazolinones and benzisothiazolinones; and mixtures thereof.

Exemplary antifreeze agents, include, but are not limited to ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

iv. Carriers

In some aspects, the additive includes a carrier. In some aspects, the additive includes a liquid or solid carrier. In some aspects, the additive includes an organic or inorganic carrier. In some aspects, a liquid carrier may be a diluting solvent. Exemplary liquid carriers include, but are not limited to: water; aqueous liquids; petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; fatty acid esters; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like; toluene; xylene; petroleum naphtha; crop oil; acetone; methyl ethyl ketone; cyclohexanone; trichloroethylene; perchloroethylene; ethyl acetate; amyl acetate; butyl acetate; propylene glycol monomethyl ether and diethylene glycol monomethyl ether; methyl alcohol; ethyl alcohol; isopropyl alcohol; amyl alcohol; ethylene glycol; propylene glycol; glycerin; N-methyl-2-pyrrolidinone; N;N-dimethyl alkylamides; dimethyl sulfoxide; and liquid fertilizers, as well as mixtures thereof. Exemplary solid carriers include, but are not limited to: silicas, silica gels, silicates, talc, kaolin, limestone, lime, chalk, bole, loess, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

### C. Packaging

In some aspects, the formulation can be in the form of a single package formulation containing the pyridine carboxylate herbicide. In some aspects, the formulation can be in the form of a single package formulation containing the pyridine carboxylate herbicide and further including at least one additive. In some aspects, the formulation can be in the form of a multi-package formulation, such as a two-package formulation, wherein one package contains containing the pyridine carboxylate herbicide while the other package contains at least one additive. In some aspects of the two-package formulation, the formulation including containing the pyridine carboxylate herbicide and the formulation including at least one additive are mixed before application and then applied simultaneously. In some aspects, the mixing is performed as a tank mix (e.g., the formulations are mixed immediately before or upon dilution with water). In some aspects, the formulation including containing the pyridine carboxylate herbicide and the formulation including at least one additive are not mixed as a tank mix, but rather are applied sequentially (in succession), for example, immediately or within 1 hour, within 2 hours, within 4 hours, within 8 hours, within 16 hours, within 24 hours, within 2 days, or within 3 days, of each other.

### VI. Methods of Use

The formulations disclosed herein can be applied in any known technique for applying herbicides. Exemplary application techniques include, but are not limited to, spraying, atomizing, dusting, spreading, or direct application into water. The method of application can vary depending on the intended purpose. In some aspects, the method of application can be chosen to ensure the finest possible distribution of the formulations disclosed herein.

In some aspects, a method of controlling undesirable vegetation which comprises contacting the vegetation or the locus thereof with or applying to the soil or water to prevent the emergence or growth of vegetation any of the formulations is disclosed herein.

The formulations disclosed herein can be applied pre-emergence (before the emergence of undesirable vegetation) or post-emergence (e.g., during or after emergence of the undesirable vegetation). In some aspects, the composition is applied post-emergence to the undesirable vegetation.

In some aspects, when the formulations are used in crops, the formulations can be applied before seeding of the crop plants. In some aspects, when the formulations are used in crops, the formulations can be applied after seeding and before or after the emergence of the crop plants. In some aspects, the formulations disclosed herein show good crop tolerance even when the crop has already emerged and can be applied during or after the emergence of the crop plants.

In some aspects, the formulations disclosed herein are applied to vegetation or an area adjacent the vegetation or applying to soil or water to prevent the emergence or growth of vegetation by spraying (e.g., foliar spraying). In some aspects, the spraying techniques use, for example, water as carrier and spray volume rates of from 2 liters per hectare (L/ha) to 2000 L/ha (e.g., from 10-1000 L/ha or from 50-500 L/ha). In some aspects, the formulations disclosed herein are applied by the low-volume or the ultra-low-volume method, wherein the application is in the form of micro granules. In some aspects, wherein the formulations disclosed herein are less well tolerated by certain crop plants, the formulations can be applied with the aid of the spray apparatus in such a way that they come into little contact, if any, with the leaves of the sensitive crop plants while reaching the leaves of undesirable vegetation that grows underneath or on the bare soil (e.g., post-directed or lay-by). In some aspects, the formulations disclosed herein can be applied as dry formulations (e.g., granules, powders, or dusts).

In some aspects, wherein the undesirable vegetation is treated post-emergence, the formulations disclosed herein are applied by foliar application. In some aspects, herbicidal activity is exhibited by the compounds of the mixture when they are applied directly to the plant or to the locus of the plant at any stage of growth or before planting or emergence. The effect observed can depend upon the type of undesirable vegetation to be controlled, the stage of growth of the undesirable vegetation, the application parameters of dilution and spray drop size, the particle size of solid components, the environmental conditions at the time of use, the specific compound employed, the specific adjuvants and carriers employed, the soil type, and the like, as well as the amount of chemical applied. In some aspects, these and other factors can be adjusted to promote non-selective or selective herbicidal action.

The formulations and methods disclosed herein can be used to control undesirable vegetation in a variety of applications. The formulations and methods disclosed herein can be used for controlling undesirable vegetation in areas including, but not limited to, farmland, turfgrass, pastures, grasslands, rangelands, fallow land, rights-of-way, aquatic settings, tree and vine, wildlife management areas, or rangeland. In some aspects, the undesirable vegetation is controlled in a row crop. Exemplary crops include, but are not limited to, wheat, barley, triticale, rye, teff, oats, maize (corn), cotton, soy, sorghum, rice, millet, sugarcane, and range land (e.g., pasture grasses). In some aspects, the formulations and methods disclosed herein can be used for controlling undesirable vegetation in maize (corn), wheat, barley, rice, sorghum, millet, oats, or a combination thereof. In some aspects, the formulations and methods disclosed herein can be used for controlling undesirable vegetation in broadleaf crops. In some aspects, the formulations and methods disclosed herein can be used for controlling undesirable vegetation in canola, flax, sunflower, soy, or cotton. In some aspects, the formulations and methods herein can be used in range and pasture lands. In some aspects, the formulations and methods disclosed herein can be used in industrial vegetation management (IVM) or for utility, pipeline, roadside, and railroad rights-of-way applications. In some aspects, the formulations and methods disclosed herein can also be used in forestry (e.g., for site preparation or for combating undesirable vegetation in plantation forests). In some aspects, the formulations and methods disclosed herein can be used to control undesirable vegetation in conservation reserve program lands (CRP), trees, vines, grasslands, and grasses grown for seeds. In some aspects, the formulations and methods disclosed herein can be used on lawns (e.g., residential, industrial, and institutional), golf courses, parks, cemeteries, athletic fields, and sod farms.

By way of non-limiting illustration, examples of some aspects of the present disclosure are given below. Parts and percentages are on a per weight basis unless otherwise indicated.

### Examples

### Solubility Testing

The solubility of the pyridine carboxylate herbicides was tested in a variety of organic solvents. Table 2 lists the tested solvents, with examples of commercial products that contain these solvents.

TABLE 2
Solvents Used in Solubility Testing

| | | | Commercial |
|---|---|---|---|
| Solvent | Solvent class | CAS# | Products(s) |
| Benzyl alcohol | alcohol | 100-51-6 | |
| 2-Ethylhexanol | alcohol | 104-76-7 | |
| N-butyl-2-pyrolidinone | amide | 3470-98-2 | Tamisolve ® NxG |
| N,N-dimethyl | amide | 14433-76-2 | Hallcomid ® M-10 |
| decanamide | | | |
| N,N-dimethyl-9- | amide | 1356964-77-6 | Hallcomid ® 1025 |
| decenamide | | | |
| N,N-dimethyl-lactamide | amide | 35123-06-9 | Agnique ® AMD 3L |
| N,N-dimethyl | amide | 308062-09-1 | Genagen ® 4166/ |
| octanamide + N,N- | | | Agnique ® KE 3658/ |
| dimethyl decanamide, | | | Hallcomid ® M-8-10 |
| c = {0.5 + 0.5} | | | |
| 2,6-Dimethylnaphthalene | aromatic | 64742-94-5 | Aromatic 200ND |
| 1,2,4-Trimethylbenzene | aromatic | N/A | Aromatic 100 |
| Propylene carbonate | carbonate | 108-32-7 | Jeffsol ® AG-1555 |
| Dimethyl glutarate | ester | 1119-40-0 | |
| 2-Ethylhexyl-L-Lactate | ester | 6283-86-9/ | Purasolv ® EHL |
| | | 186817-80-1 | |
| C8-C10 Glycerides | ester | 73398-61-5 | Stepan ® 108 |
| Dodecanoic acid methyl | ester | 68919-53-9 | Agnique ® ME 18 |
| ester + methyl | | | SD-F |
| tetradecanoate, c = | | | |
| {0.71 + 0.29} | | | |
| 2-Hydroxypropanoic | ester | 97-64-3 | Purasolv ® EL/ |
| acid ethyl ester | | | Steposol ® SC |
| Benzyl Acetate | ester | 140-11-4 | Jeffsol ® AG 1705 |
| Butyl benzoate | ester | | Jeffsol ® AG 1700 |
| Methyl 5- | ester/amide | 1174627-68-9 | Rhodiasolv ® |
| (dimethylamino)-2- | | | Polarclean |
| methyl-5-oxopentanoate + | | | |
| dimethyl-2-methyl- | | | |
| glutarate c = {0.95 + | | | |
| 0.05} | | | |
| Dipropylene glycol | glycol ether | 34590-94-8 | Dowanol ® DPM |
| monomethyl ether | | | |
| 2-Phenoxyethylene | glycol ether | | Dowanol ® Eph |
| glycol | | | |
| 2-Butoxyethanol | glycol ether | 111-76-2 | Butyl Cellosolve ® |
| Diethylene glycol mono- | glycol ether | 112-34-5 | Butyl Carbitol ® |
| butyl ether | | | |
| 2-Heptanone | ketone | 110-43-0 | |
| Cyclopentanone | ketone | 120-92-3 | |
| Acetophenone | ketone | 98-86-2 | |
| Dihydrolevoglucosenone | ketone | | Cyrene ® |
| C10-C16 Branched | non polar oil | 64742-47-8 | Isopar ® M |
| Alkanes | | | |
| Polyoxyethylene | polymeric | 69029-39-6 | Polyglycol 26-2 |
| polyoxypropylene | ether | | |
| mono(di-sec- | | | |
| butylphenyl) ether | | | |

Dowanol ® is a registered trademark of the Dow Chemical Company, Midland, Michigan, USA. Cellosolve ® and Carbitol ® are registered trademarks of the Union Carbide Corporation, Seadrift, Texas, USA.

For the first solubility test, approximately 40 to 45 mg of the pyridine carboxylate herbicide Compound A was mixed with about 700 to 900 mg of each test solvent, forming a solubility test mixture that was about 5 to 7 wt % (g/g) of the pyridine carboxylate herbicide in each solvent. Each mixture was heated from −10° C. to 60° C., at a heating rate of 0.1° C./min, and the mixture was observed to determine the temperature at which the mixture became transparent. The temperature at which the mixture became clear is identified as the solubility temperature in Table 3. If the herbicide dissolved immediately at a temperature of −10° C., the solubility temperature in Table 3 is given as “−10° C.” For some mixtures, the results were ambiguous, because the mixture was too dark to determine if the lack of transparency was due to cloudiness (e.g., insolubility) or the color of the mixture. For some mixtures, the color of the mixture changed from colorless or tan to a dark green or dark brown. For some mixtures, if no transparency was observed, it was determined that the pyridine carboxylate herbicide was not soluble.

TABLE 3
Results of First Solubility Tests

| | | Cmpd A | Solubility | |
|---|---|---|---|---|
| | | wt % | Temp | |
| Solvent | Commercial Name | (g/g) | (° C.) | Transparency |
| N-butyl-2-pyrolidinone | Tamisolve ® NxG | 5.16 | −10 | Clear |
| N,N-dimethyl octanamide + | Hallcomid ® M-8-10 | 6.18 | −10 | Clear |
| N,N-dimethyl decanamide, | | | | |
| c = {0.5 + 0.5} | | | | |
| Propylene carbonate | Jeffsol ® AG-1555 | 4.74 | −10 | Clear |
| 1,2,4-Trimethylbenzene | Aromatic 100 | 6.44 | | None |
| N,N-dimethyl-lactamide | Agnique ® AMD 3L | 5.22 | −10 | Clear |
| Dipropylene glycol methyl | Dowanol ® DPM | 5.73 | −10 | Clear |
| ester | | | | |
| Methyl 5-(dimethylamino)-2- | Rhodiasolv ® | 5.38 | −10 | Clear |
| methyl-5-oxopentanoate + | Polarclean | | | |
| dimethyl-2-methyl-glutarate, | | | | |
| c = {0.95 + 0.05} | | | | |
| 2-Heptanone | | 6.92 | | Ambiguous |
| 2,6-Dimethylnaphthalene | Aromatic 200 ND | 5.69 | | None |
| Benzyl alcohol | | 5.3 | 14.5 | Clear |
| N,N-dimethyl-9-decenamide | Hallcomid ® 1025 | 6.19 | −10 | Clear |
| Benzyl Acetate | Jeffsol ® AG 1705 | 5.55 | | Ambiguous |
| 2-Ethylhexyl-L-Lactate | Purasolv ® EHL | 5.91 | | Ambiguous |
| C10-C16 Branched Alkanes | Isopar ® M | 6.95 | | None |
| Cyclopentanone | | 6.25 | −10 | Clear |
| Diethylene glycol mono-butyl | Butyl Carbitol ® | 5.88 | −10 | Clear |
| ether | | | | |
| 2-Butoxyethanol | Butyl Cellosolve ® | 6.28 | −10 | Clear |
| Acetophenone | | 5.36 | 37.4 | Clear |
| Dimethyl Glutarate | | 5.12 | −10 | Clear |
| 2-Ethyl-1-hexanol | | 6.79 | | None |
| 2-Hydroxypropanoic acid | Purasolv ® EL | 5.44 | | Ambiguous |
| ethyl ester | | | | |
| Dodecanoic acid methyl | Agnique ® ME 18 SD- | 6.31 | | None |
| ester + methyl tetradecanoate, | F | | | |
| c = {0.71 + 0.29} | | | | |
| C8-C10 Glycerides | Stepan ® 108 | 6.12 | | None |
| Polyoxyethylene | Polyglycol 26-2 | 6.23 | 41.8 | Clear |
| polyoxypropylene mono(di- | | | | |
| sec-butylphenyl) ether | | | | |
| Butyl benzoate | Jeffsol ® 1700 | 5.56 | | None |
| Dihydrolevoglucosenone | Cyrene ® | 4.91 | −10 | Clear |
| 2-Phenoxyethanol | Dowanol ® EPh | 6.01 | −10 | Clear |

For the second solubility test, approximately 85 or 190 mg of the pyridine carboxylate herbicide Compound A was mixed with about 800 to 1000 mg of each test solvent, forming a solubility test mixture that was about 10 to 24 wt % (g/g) of the pyridine carboxylate herbicide in each solvent. Each mixture was heated from 0° C. to 60° C., at a heating rate of 0.1° C./min, and the mixture was observed to determine the temperature at which the mixture became transparent. The temperature at which the mixture became clear is identified as the solubility temperature in Table 4. If the herbicide dissolved immediately at a temperature of 0° C., the solubility temperature in Table 4 is given as “<0.” For some mixtures, the results were ambiguous, because the mixture was too dark to determine if the lack of transparency was due to cloudiness (e.g., insolubility) or the color of the mixture. For some mixtures, the color of the mixture changed from colorless or tan to a dark green or dark brown. For some mixtures, if no transparency was observed, it was determined that the pyridine carboxylate herbicide was not soluble.

TABLE 4
Results of Second Solubility Tests

| | | Cmpd A | |
|---|---|---|---|
| Solvent (or | Solvent | wt % | Solubility |
| Commercial Name) | Class | (g/g) | Temp ° C. |
| Hallcomid ® M-8-10 | amide | 23.55 | <0 |
| Hallcomid ® M-10 | amide | 23.35 | <0 |
| Hallcomid ® 1025 | amide | 11.99 | <0 |
| Hallcomid ® 1025 | amide | 23.43 | <0 |
| Jeffsol ® AG 1555 | carbonate | 12.79 | 15.4 |
| Jeffsol ® AG 1555 | carbonate | 18.46 | 27.39 |
| Rhodiasolv ® Polarclean | ester/amide | 10.59 | <0 |
| Rhodiasolv ® Polarclean | ester/amide | 20.12 | <0 |
| Dimethyl Glutarate | ester | 19 | 36.37 |
| Jeffsol ® AG 1705 | ester | 19.55 | NONE |
| 2-heptanone | ketone | 23.58 | NONE |
| Acetophenone | ketone | 19.69 | 26.98 |
| Cyclopentanone | ketone | 21.08 | <0 |

### Degradation Testing

During the solubility testing, some mixtures of the pyridine carboxylate herbicide with certain solvents underwent a color change, to a dark green or dark brown, or a darkening while the mixture aged. This presented a visual indication that the pyridine carboxylate herbicide may be degrading or becoming otherwise unstable in the solvent. Further testing was performed to determine if the pyridine carboxylate herbicide was degrading over time while in contact with the particular solvent.

For the degradation test, approximately 50 mg of the pyridine carboxylate herbicide Compound A was mixed with about 950 microliter (μL) of each test solvent, forming a test mixture at a concentration of about 125 mmol/L of Compound A in each solvent. Portions of each text mixture were store at −10° C. or at 54° C. for two weeks. Each test mixture was evaluated by ¹⁹F NMR to determine the concentration of Compound A remaining in the test solution after storage and whether degradation products of Compound A could be observed.

TABLE 5
Results of Degradation Tests

| | | Cmpd A | | |
|---|---|---|---|---|
| | | (mmol/L) | | Change |
| Solvent | Solvent class | −10° C. | 54° C. | (%) |
| benzyl alcohol | alcohol | 67.8 | 1.2 | −98.2 |
| Tamisolve ® NxG | amide | 124.3 | 124.0 | −0.2 |
| Hallcomid ® 1025 | amide | 119.2 | 118.9 | −0.3 |
| Agnique R AMD 3L | amide | 120.5 | 93.7 | −22.3 |
| Hallcomid ® M-8-10 Ultra | amide | 119.0 | 116.8 | −1.9 |
| Hallcomid ® M-8-10 | amide | 120.5 | 119.9 | −0.5 |
| Hallcomid ® M-10 | amide | 108.7 | 110.2 | 1.3 |
| Jeffsol ® AG 1555 | carbonate | 123.1 | 123.6 | 0.4 |
| Dimethyl glutarate | ester | 124.7 | 123.1 | −1.3 |
| Purasolv ® EL | ester | 94.1 | 0.0 | −100.0 |
| Jeffsol ® 1705 | ester | 124.4 | 116.0 | −6.8 |
| Rhodiasolv ® Polarclean | ester/amide | 124.7 | 118.9 | −4.7 |
| Dowanol ® DPM | glycol ether | 123.0 | 109.4 | −11.1 |
| Butyl Carbitol ® | glycol ether | 121.2 | 86.3 | −28.8 |
| Dowanol ® EPh | glycol ether | 90.4 | 4.3 | −95.2 |
| Butyl Cellosolve ® | glycol ether | 112.5 | 23.8 | −78.8 |
| Proglyde DMM | aprotic glycol diether | 121.1 | 120.3 | −0.6 |
| 2-heptanone | ketone | 123.3 | 132.6 | 7.5 |
| cyclopentanone | ketone | 124.7 | 136.0 | 9.0 |
| acetophenone | ketone | 124.1 | 123.6 | −0.4 |
| Cyrene | ketone | 124.2 | 120.9 | −2.7 |
| Polyglycol 26-2 | polymeric ether | 82.0 | 72.6 | −11.5 |
| Amgard ® TOF | phosphate ester | 124.6 | 126.1 | 1.2 |

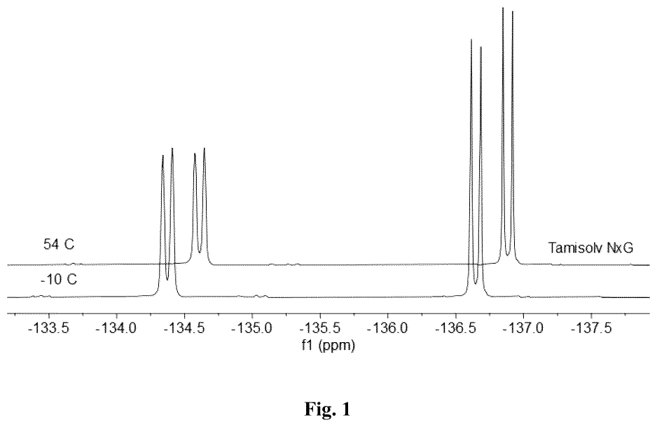

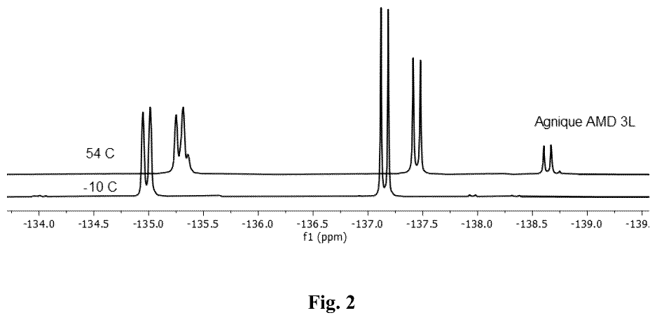

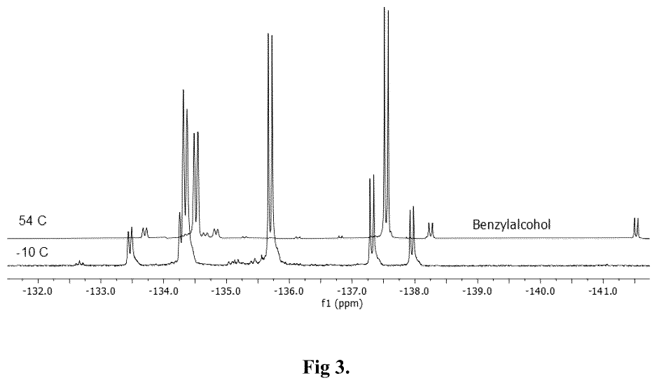

The results of the degradation study show that Compound A is stable in many solvents when stored at 54° C. FIG. 1 shows the 19F NMR spectra of Compound A dissolved in Tamisolve® NxG after storage at either −10° C. or 54° C., and little or no degradation of Compound A is seen at either temperature. Compound A was found to be stable in most amide solvents, although some degradation was seen in Agnique® AMD 3L at 54° C. (see FIG. 2). However, Compound A degrades when mixed with benzyl alcohol, some esters (e.g., Purasolv® EL), and some glycol ethers (e.g., Dowanol® EPh), even when stored for two weeks at −10° C. This degradation is even greater when Compound A is mixed with these solvents and stored at 54° C. for two weeks. FIG. 3 shows the spectra of Compound A dissolved in benzyl alcohol, and degradation is seen at both storage temperatures. Compound A also degrades in most glycol ethers (e.g., Dowanol® DPM), although not aprotic glycol diethers (e.g., Proglyde® DMM), when stored at 54° C. for two weeks.

The formulations and methods of the appended claims are not limited in scope by the specific formulations and methods described herein, which are intended as illustrations of a few aspects of the claims and any formulations and methods that are functionally equivalent are intended to fall within the scope of the claims. Various modifications of the formulations and methods in addition to those shown and described herein are intended to fall within the scope of the appended claims. Further, while only certain representative formulations and method steps disclosed herein are specifically described, other combinations of the formulations and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various aspects, the terms “consisting essentially of” and “consisting of” can be used in place of “comprising” and “including” to provide for more specific aspects of the disclosure and are also disclosed. Other than in the examples, or where otherwise noted, all numbers expressing quantities of ingredients, reaction conditions, and so forth used in the specification and claims are to be understood to be construed in light of the number of significant digits and ordinary rounding approaches, and not as an attempt to limit the application of the doctrine of equivalents to the scope of the claims.

What is claimed is:

1. A herbicidal formulation, comprising:
(a) a pyridine carboxylate herbicide as defined by Formula I: 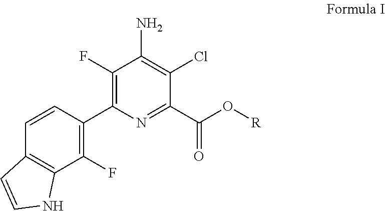
wherein R is H, C₁-C₆ alkyl, substituted C₁-C₆ alkyl, C₂-C₆ alkenyl, substituted C₂-C₆ alkenyl, C₂-C₆ alkynyl, substituted C₂-C₆ alkynyl, phenyl, substituted phenyl, C₇-C₁₂ arylalkyl, substituted C₇-C₁₂ arylalkyl, C₁-C₆ alkoxy, C₁-C₆ alkoxyalkyl, C₇-C₁₂ aryloxyalkyl, C₁-C₆ alkylthio, C₁-C₆ alkylthioalkyl, C₇-C₁₂ arylthioalkyl,
or an agriculturally acceptable N-oxide or salt thereof; and
(b) an additional component;
wherein the additional component is selected from the group consisting of a solvent, a co-solvent, a diluent, an emulsifier, a carrier, a binding agent, microcapsules or microcapsule-forming ingredients, an adjuvant, a built-in adjuvant, another herbicide, a safener, and another agricultural chemical; and
wherein the formulation is selected from the group consisting of emulsifiable concentrates, oil-in-water emulsions, water-in-oil emulsions, microemulsions, suspensions, suspension concentrates, capsule suspensions, suspoemulsions, oil dispersions, soluble liquids, powders, granules, tablets, briquettes, gels, pastes, and greases.

2. The formulation of claim 1, wherein the pyridine carboxylate herbicide is selected from the group consisting of:

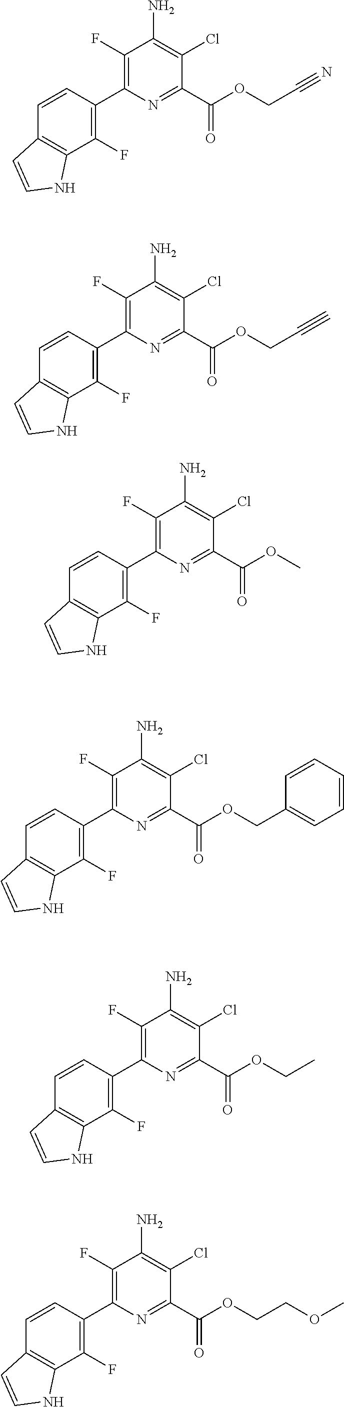 [SMILES: N#CCOC(=O)c1nc(-c2ccc3cc[nH]c3c2F)c(F)c(N)c1Cl ; C#CCOC(=O)c1nc(-c2ccc3cc[nH]c3c2F)c(F)c(N)c1Cl ; COC(=O)c1nc(-c2ccc3cc[nH]c3c2F)c(F)c(N)c1Cl ; Nc1c(F)c(-c2ccc3cc[nH]c3c2F)nc(C(=O)OCc2ccccc2)c1Cl ; CCOC(=O)c1nc(-c2ccc3cc[nH]c3c2F)c(F)c(N)c1Cl ; COCCOC(=O)c1nc(-c2ccc3cc[nH]c3c2F)c(F)c(N)c1Cl]

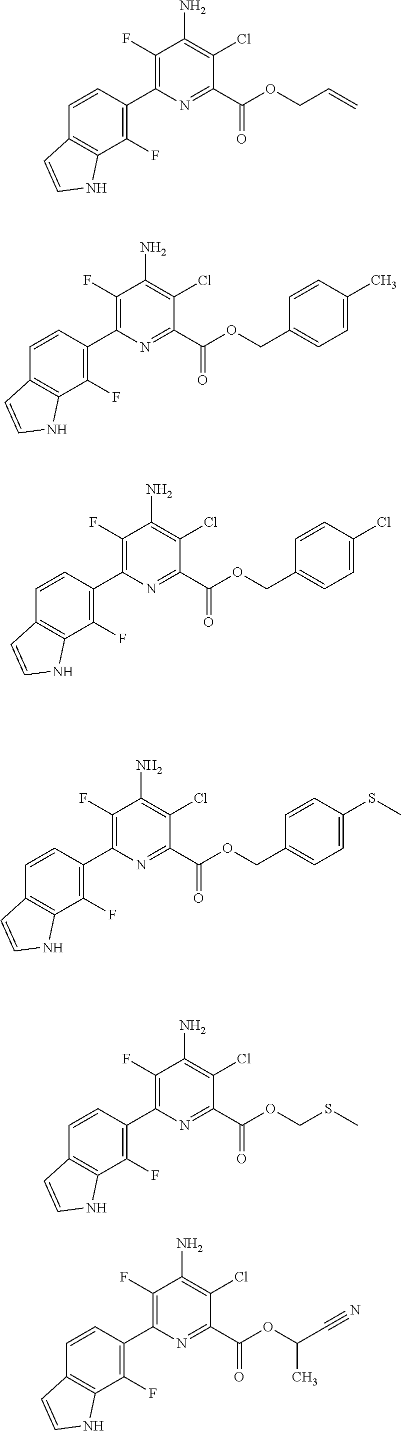 [SMILES: C=CCOC(=O)c1nc(-c2ccc3cc[nH]c3c2F)c(F)c(N)c1Cl ; Cc1ccc(COC(=O)c2nc(-c3ccc4cc[nH]c4c3F)c(F)c(N)c2Cl)cc1 ; Nc1c(F)c(-c2ccc3cc[nH]c3c2F)nc(C(=O)OCc2ccc(Cl)cc2)c1Cl ; CSc1ccc(COC(=O)c2nc(-c3ccc4cc[nH]c4c3F)c(F)c(N)c2Cl)cc1 ; CSCOC(=O)c1nc(-c2ccc3cc[nH]c3c2F)c(F)c(N)c1Cl ; CC(C#N)OC(=O)c1nc(-c2ccc3cc[nH]c3c2F)c(F)c(N)c1Cl]

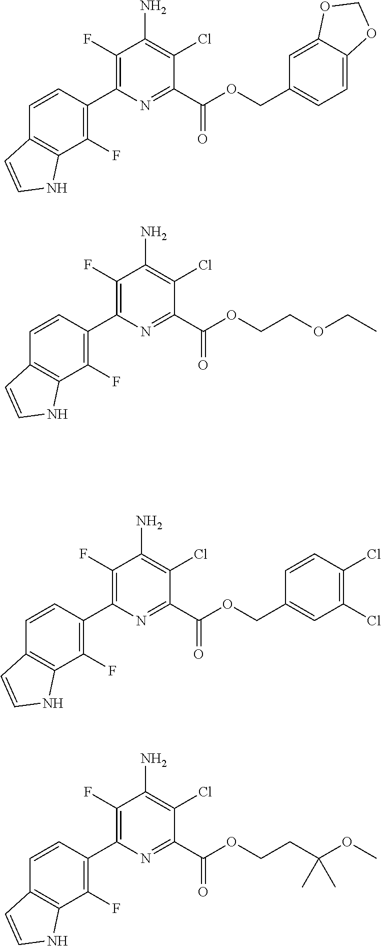 [SMILES: Nc1c(F)c(-c2ccc3cc[nH]c3c2F)nc(C(=O)OCc2ccc3c(c2)OCO3)c1Cl ; CCOCCOC(=O)c1nc(-c2ccc3cc[nH]c3c2F)c(F)c(N)c1Cl ; Nc1c(F)c(-c2ccc3cc[nH]c3c2F)nc(C(=O)OCc2ccc(Cl)c(Cl)c2)c1Cl ; COC(C)(C)CCOC(=O)c1nc(-c2ccc3cc[nH]c3c2F)c(F)c(N)c1Cl]

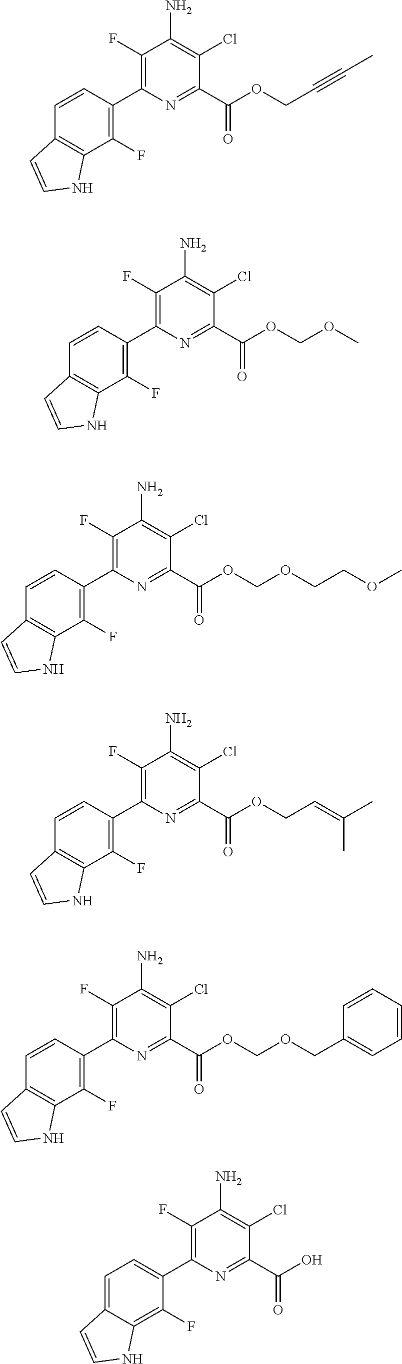 [SMILES: CC#CCOC(=O)c1nc(-c2ccc3cc[nH]c3c2F)c(F)c(N)c1Cl ; COCOC(=O)c1nc(-c2ccc3cc[nH]c3c2F)c(F)c(N)c1Cl ; COCCOCOC(=O)c1nc(-c2ccc3cc[nH]c3c2F)c(F)c(N)c1Cl ; CC(C)=CCOC(=O)c1nc(-c2ccc3cc[nH]c3c2F)c(F)c(N)c1Cl ; Nc1c(F)c(-c2ccc3cc[nH]c3c2F)nc(C(=O)OCOCc2ccccc2)c1Cl ; Nc1c(F)c(-c2ccc3cc[nH]c3c2F)nc(C(=O)O)c1Cl]

3. The formulation of claim 1, wherein the formulation is a liquid concentrate formulation and wherein the pyridine carboxylate herbicide is present in the liquid concentrate formulation at a concentration from 1 to 500 gram active ingredient per liter (g ai/L) of the liquid formulation.

4. The formulation of claim 3, wherein the liquid formulation comprises a solvent or a cosolvent selected from the group consisting of a long chain alkyl amide, an alkylene carbonate, a methylated seed oil, a fatty acid ester, a triglyceride ester, an aprotic glycol diether, a ketone, a phosphate triester, or a polymeric ether.

5. The formulation of claim 1, wherein the formulation is a liquid tank mix formulation and wherein the pyridine carboxylate herbicide is present in the liquid tank mix formulation at a concentration from 0.006 to 100 gram active ingredient per liter (g ai/L) of the liquid tank mix formulation.

6. The formulation of claim 5, wherein the liquid tank mix formulation comprises a solvent or a cosolvent selected from the group consisting of a long chain alkyl amide, an alkylene carbonate, a methylated seed oil, a fatty acid ester, a triglyceride ester, an aprotic glycol diether, a ketone, a phosphate triester, or a polymeric ether.

7. The formulation of claim 1, wherein the formulation is a solid formulation and the pyridine carboxylate herbicide is present in the solid formulation at a concentration from 1 to 500 gram active ingredient per kilogram (g ai/kg) of the solid formulation.
